(19) United States
(12) Patent Application Publication
(10) Pub. No.: US 2026/0135612 A1
(43) Pub. Date: May 14, 2026

(54) COMMUNICATION SYSTEM AND COMMUNICATION METHOD

(71) Applicant: Jia-Chin LIN, Taoyuan City (TW)

(72) Inventor: Jia-Chin LIN, Taoyuan City (TW)

(21) Appl. No.: 19/275,247

(22) Filed: Jul. 21, 2025

(30) Foreign Application Priority Data
Nov. 13, 2024 (TW) 113143683

(51) Int. Cl. H04B 7/185; H04W 74/0833

(52) U.S. Cl. CPC H04B 7/18519; H04B 7/18543; H04B 7/18589; H04W 74/0833

(57) ABSTRACT

A communication system and a communication method are provided. The method includes pre-acquiring frequency- and time-domain compensation parameters based on system parameters. After broadcasting the primary synchronization signal, the original preset frequency band and time are adjusted using these parameters to compensate for a common frequency offset and a common delay at the base station. The method further includes: calculating likelihood measures to identify active user equipment; performing peak searching to estimate residual frequency and time errors; and sending these estimates to user equipment detected active for necessary adjustments.

### CROSS-REFERENCE TO RELATED APPLICATIONS

This application claims priority of No. 113143683 filed in Taiwan, R.O.C. on Nov. 13, 2024 under 35 USC 119, the entire content of which is hereby incorporated by reference.

### BACKGROUND OF THE INVENTION

### Field of the Invention

The present invention relates to the technology for wireless communication, more particularly, the present invention relates to a communication system and a communication method, adapted for non-terrestrial networks (NTNs) and Narrowband Internet of Things (NB-IoT).

### Description of the Related Art

The Third Generation Partnership Project (3GPP) began exploring the integration of satellite communications with 5G terrestrial wireless networks in 2019, resulting in technical reports TR 38.811 and TR 38.821 from Releases 15 and 16, respectively. Subsequently, a working item on 5G New Radio (NR) in NTNs was introduced in Release 17, alongside a study item focusing on supporting the NB-IoT protocol within NTNs.

NB-IoT is a recently developed framework within the 3GPP specifications, tailored to accommodate a large number of user equipments (UEs) in massive machine-type communication (mMTC) scenarios. In this context, UEs transmit narrowband physical random access channel (NPRACH) preambles, similar to how mobile devices request radio resources in mobile communication networks through random access (RA) procedures. The NPRACH, comprising consecutive subcarriers allocated for preamble transmission, is crucial for the base station (BS) to discern signals from various active UEs with diverse channel impairments, identify these active UEs, and estimate the relevant channel parameters for each uplink.

The integration of NB-IoT into NTNs presents several challenges, as the existing NB-IoT specifications were originally designed for terrestrial networks (TNs) and do not account for NTN channel impairments, such as long propagation delays, high Doppler shifts, and constrained power availability. To adapt NB-IoT for NTN use, modifications to the current protocols may be necessary. However, these modifications must be kept minimal to ensure backward compatibility with the existing 5G infrastructure. A key area for potential changes is the NPRACH procedure, which in its current form is not equipped to handle satellite communication challenges, such as long propagation delays and high Doppler shifts.

### BRIEF SUMMARY OF THE INVENTION

In view of this, the embodiment of the present invention is to provide a communication system and a communication method, suitable for a non-terrestrial network (NTN) Narrowband Internet of Things (NB-IoT) and compatible with terrestrial network (TN) communication.

Another objective of the preferred embodiment of the present invention is to provide a communication system and communication method suitable for non-terrestrial networks (NTNs), which can be used to increase the success probability of the random access process in non-terrestrial networks.

Another objective of the preferred embodiment of the present invention is to provide a communication system and communication method that allow a user equipment, after random access, to achieve alignments both in the time domain and in the frequency domain on signal reception at the base station based on parameters provided by the base station.

In view of this, a preferred embodiment of the present invention provides a communication system. The communication system includes a base station (BS). The base station (BS) includes a detection and estimation unit and a dedicated channel transmission. The detection and estimation unit receives a received signal, configured to perform a two-dimensional (2-D) correlation function calculation for multiple user equipments and obtain multiple likelihood measures at candidates of residual frequency error (RFE) and at candidates of residual time error (RTE) for each user equipment (UE), to detect whether a user equipment (UE) is considered active based on whether at least one of the multiple likelihood measures corresponding to the user equipment (UE) exceeds a threshold value. The dedicated channel transmission is in communication with the detection and estimation unit, configured to deliver a response to the user equipment (UE) considered active.

Another preferred embodiment of the present invention provides a communication system. The communication system includes a base station (BS), which emits a communication beam toward the Earth's surface, wherein the communication beam encompasses a specific service area. The base station includes a compensation unit. Before the base station broadcasts a primary synchronization signal (PSS), the compensation unit obtains a frequency-domain (FD) compensation parameter and a time-domain (TD) compensation parameter that are pre-calculated and pre-stored using system parameters, wherein, after the primary synchronization signal (PSS) is broadcast, the base station (BS) receives a received signal in a post-compensated frequency band adjusted using the frequency-domain (FD) compensation parameter from a first preset frequency band in a specification and within a post-compensated time duration adjusted using the time-domain (TD) compensation parameter from a first preset time duration in the specification to compensate for a frequency shift caused by Doppler effect and a propagation delay, respectively.

In a preferred embodiment of the present invention, the primary synchronization signal (PSS) is broadcast on a pre-compensated frequency band adjusted using the frequency-domain (FD) compensation parameter from a second preset frequency band and within a pre-compensated time duration adjusted using the time-domain (TD) compensation parameter from a second preset time duration, wherein in the specification, the primary synchronization signal (PSS) is broadcast on the second preset frequency band and within the second preset time duration.

Another preferred embodiment of the present invention provides a communication method. The method includes: receiving a received signal; performing a two-dimensional (2-D) correlation function calculation to the received signal for multiple user equipments, evaluating multiple likelihood measures at candidates of residual frequency error (RFE) and at candidates of residual time error (RTE) for each user equipment; detecting whether a user equipment is considered active based on whether at least one of the multiple likelihood measures corresponding to the user equipment exceeds a threshold value; and delivering a response to the user equipment considered active.

Another preferred embodiment of the present invention provides a communication method. The method includes: before broadcasting a primary synchronization signal (PSS), obtaining a frequency-domain (FD) compensation parameter and a time-domain (TD) compensation parameter that are pre-calculated and pre-stored using the system parameters; after the primary synchronization signal (PSS) is broadcast, receiving a received signal in a post-compensated frequency band adjusted using the frequency-domain (FD) compensation parameter from a first preset frequency band in a specification and within a post-compensated time duration adjusted using the time-domain (TD) compensation parameter from a first preset time duration in the specification to compensate a common Doppler frequency shift, which is considered large due to satellite movement, and a common propagation delay, which is considered long due to satellite altitude.

In the communication method according to a preferred embodiment of the present invention, the communication method further comprises: broadcasting the primary synchronization signal (PSS) on a pre-compensated frequency band adjusted using the frequency-domain (FD) compensation parameter from the second preset frequency band and within a pre-compensated time duration adjusted using the time-domain (TD) compensation parameter from the second preset time duration. According to the specification, the primary synchronization signal is defined to be broadcast on the second preset frequency band and within the second preset time duration.

The preferred embodiment of the present invention proposes pre-compensation and post-compensation in both the frequency domain and the time domain. This can enable a non-terrestrial network (NTN) base station (BS) to successfully detect random access channel preambles sent from a user equipment (UE) in the service area without changing the specifications of the user equipment (UE) that were originally specified for TNs. In another preferred embodiment, by performing two-dimensional likelihood measure calculations at multiple candidates of residual frequency error (RFE) and at multiple candidates of residual time error (RTE) for each user equipment (UE), the base station (BS) can effectively identify the user equipment (UE) that is in an active state. This, in turn, increases the success probability of random access preamble detection in terms of low miss probability and low false-alarm probability on NPRACH preamble detection. Furthermore, the two-dimensional likelihood measure calculation in the preferred embodiment of the present invention can also yield residual frequency error (RFE) estimates and residual time error (RTE) estimates. The base station (BS) can transmit these residual frequency error (RFE) estimates and residual time error (RTE) estimates to the corresponding user equipment devices detected active. As a result, the user equipments (UEs) can use these estimates to individually adjust time and frequency of their local oscillators for reducing multiple-access interference (MAI), which is also known as intercarrier interference (ICI). This, therefore, reduces false-alarm and miss probabilities on NPRACH detection and improves communication performance and robustness in non-terrestrial networks (NTNs).

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

The accompanying drawings provided are intended to further assist people having ordinary skills in the art in understanding the present invention, and are incorporated as part of the description that forms the specification of the invention. The drawings illustrate exemplary embodiments of the invention and are used together with the description to explain the principles of the invention.

FIG. 1 illustrates a system block diagram of a communication system suitable for non-terrestrial networks (NTNs) according to an exemplary embodiment of the present invention.

FIG. 2 illustrates a geometric diagram of a Low Earth Orbit (LEO) working scenario for a communication system suitable for non-terrestrial networks (NTNs) according to an exemplary embodiment of the present invention.

FIG. 3 illustrates a schematic diagram showing the relationship between the elevation angle and the beam spot size for a communication system suitable for non-terrestrial networks (NTNs) according to an exemplary embodiment of the present invention.

FIG. 4 illustrates a working diagram of pre-compensation and post-compensation in the frequency domain for downlink and uplink transmissions between a base station and a user equipment in an exemplary embodiment of the present invention.

FIG. 5 illustrates a working diagram of pre-compensation and post-compensation in the time domain for a communication system suitable for non-terrestrial networks (NTNs) according to an exemplary embodiment of the present invention.

FIG. 6 illustrates a system block diagram of a communication system suitable for non-terrestrial networks (NTNs) according to an exemplary embodiment of the present invention.

FIG. 7 illustrates a simulation diagram of likelihood measures for a UE in a communication system suitable for non-terrestrial networks (NTNs) according to an exemplary embodiment of the present invention.

FIG. 8 illustrates a block diagram of the detection and estimation unit 603 for a communication system suitable for non-terrestrial networks (NTNs) according to an exemplary embodiment of the present invention.

FIG. 9 illustrates a block diagram of the mono-RACH likelihood measure computation unit 80u for UEᵤ in a communication system suitable for non-terrestrial networks (NTNs) according to an exemplary embodiment of the present invention.

FIG. 10 illustrates a block diagram of the n-th symbol-level correlator bank 90n for UEᵤ in a communication system suitable for non-terrestrial networks (NTNs) according to an exemplary embodiment of the present invention.

FIG. 11 illustrates a block diagram of the detection and estimation unit 603 for a communication system suitable for non-terrestrial networks (NTNs) according to an exemplary embodiment of the present invention.

FIG. 12 illustrates a block diagram of the n-th omni-RACH correlator bank 1102 of the detection and estimation unit 603 for a communication system suitable for non-terrestrial networks (NTNs) according to an exemplary embodiment of the present invention.

FIG. 13 illustrates a simulation environment diagram in a communication system suitable for non-terrestrial networks (NTNs) according to an exemplary embodiment of the present invention.

FIG. 14 illustrates a simulation diagram for likelihood measures for a UE in a communication system suitable for non-terrestrial networks (NTNs) according to an exemplary embodiment of the present invention.

FIG. 15 illustrates a flowchart of pre-compensation and post-compensation in a communication method suitable for non-terrestrial networks (NTNs) according to an exemplary embodiment of the present invention.

FIG. 16 illustrates a flowchart of identifying user equipments in a communication method for non-terrestrial networks (NTNs) according to an exemplary embodiment of the present invention.

FIG. 17 illustrates a sub-step flowchart of Step S1603 of identifying user equipments in a communication method suitable for non-terrestrial networks (NTNs) according to an exemplary embodiment of the present invention.

FIG. 18 illustrates a sub-step flowchart of Step S1603 of identifying user equipments in a communication method suitable for non-terrestrial networks (NTNs) according to an exemplary embodiment of the present invention.

### DETAILED DESCRIPTION OF THE INVENTION

In the following detailed description of the exemplary embodiment of the present invention, the exemplary embodiment will be illustrated in the accompanying drawings. To the extent that it is feasible and appropriate, the same reference numerals are used in the drawings and the description to refer to the same or similar components. Furthermore, the exemplary embodiments merely represent realizations for the design concept of the present invention, and the examples provided below are not intended to limit the scope of the invention.

Owing to rapid development of wireless communication technologies nowadays, the 3GPP specifications have become a key foundation for global mobile communication systems. Current 3GPP technologies encounter significant challenges related to non-terrestrial network (NTN) communication, particularly in Narrowband Internet of Things (NB-IoT) applications. The narrowband characteristics of NB-IoT can lengthen battery life and improve spectral efficiency. However, they unavoidably lead to significant intercarrier interference (ICI), which is also known as multiple access interference (MAI), occurring on NPRACH reception at a base station (BS). This interference becomes particularly severe in satellite communication environments, where the rapid movement of Low Earth Orbit (LEO) satellites results in a high Doppler frequency shift occurring in the received signal, further exacerbating the intercarrier interference. In addition, the altitudes of satellites result in long propagation delays. Therefore, signal reception and signal synchronization during the random-access process become even more difficult. These issues often lead to random access failures during connection attempts by NB-IoT devices, thereby reducing the overall reliability and performance of the communication system.

The NTN communication system, especially in the context of the fifth-generation (5G) and beyond (B5G) wireless communication networks, faces critical challenges due to the characteristics of NB-IoT applications. In particular, the relative movement between the signal source (such as a base station on a satellite) and the receiver (such as a ground station or a user equipment device) cause high Doppler frequency shift. This leads to a mismatch between the spectrum of the received signal and the preset receiving frequency band. Additionally, the altitudes of satellites, compared to conventional terrestrial base stations, are much higher, leading to a significant increase of propagation delay.

The 3GPP Releases specified that a base station (BS) must transmit the primary synchronization signal (PSS) per frame and a secondary synchronization sequence (SSS) every two frames. The length of a frame is 10 ms. A UE can accurately obtain synchronization information for the cell from the received PSS and SSS. The base station (BS) prepares to receive signal at the preset time window after the subframe conveying PSS by a specified time duration, which is generally one subframe or a few subframes. The receiving time window is also called random access opportunity (RAO). During this time window (i.e., RAO), the base station receives signals propagating via the NB-IoT physical random access channel with single carrier frequency hopping patterns. However, due to the Doppler effect, the NB-IoT physical random access channel preambles from a user equipment (UE) experience a frequency shift, while the NB-IoT physical random access channel preambles from the user equipment (UE) are also severely delayed due to the long propagation path between the user equipment (UE) and the NTN base station (BS). As a result, the base station (BS) often fails to receive any signal within the preset receiving window (i.e., the mismatch in the time domain) and/or within the preset frequency band (i.e., the mismatch in the frequency domain).

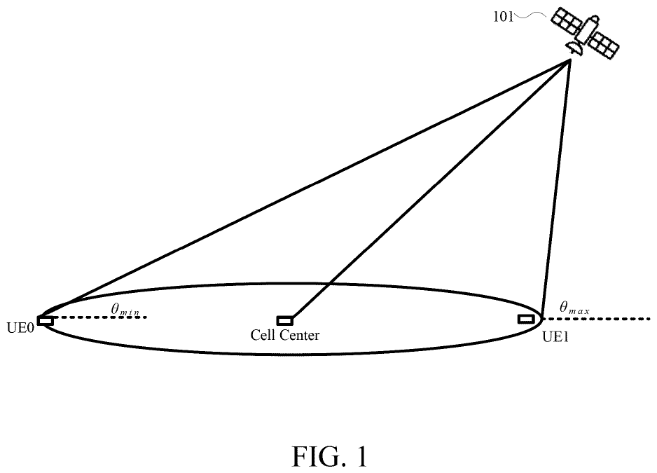

FIG. 1 illustrates a system block diagram of a communication system suitable for NTNs according to an exemplary embodiment of the present invention. Referring to FIG. 1, in this embodiment, a communication system suitable for NTNs is exemplified using the current fifth generation (5G) wireless communication network, with NB-IoT as the example. In FIG. 1, the communication system includes a base station 101 located on a satellite, and it is assumed that there are two user equipments, UE0 and UE1, within the service area of the base station 101.

In NB-IoT, the user equipment needs to establish a connection with the base station through a random access (RA) procedure. The base station 101 periodically transmits the primary synchronization signal (PSS) every frame and the secondary synchronization signal (SSS) every two frames. In this embodiment, the primary synchronization signal is exemplified by the narrowband primary synchronization signal (NPSS). People having ordinary skills in the art, after reviewing the embodiment of the present invention, will understand that the invention is also applicable to any general user equipment. Therefore, this invention is not limited thereto. For simplicity, PSS will be used as the term in the following explanation. After a user equipment (UE) within the service area of the base station (BS) receives the primary synchronization signal (PSS) and the secondary synchronization signal (SSS), it synchronizes its time and frequency with the received PSS and decodes the received SSS to obtain the time and frequency information of the random access opportunity (RAO). Then, the user equipment (UE) transmits physical random access channel (PRACH) preambles to the base station (BS) within random access opportunity (RAO). In other words, the base station 101 needs to broadcast the PSS within a fixed time interval. Additionally, the user equipment, by receiving the primary synchronization signal (PSS), accurately acquires the synchronization information for the whole service area. When the base station 101 transmits the PSS, a receiving window will be opened after a specified time duration (one subframe or several time slots). In this time window, the base station prepares to receive the Narrowband Physical Random Access Channel (NPRACH) preamble signal from the user equipment. Due to satellite movement with respect to the service area, a high Doppler frequency shift occurs with the PSS transmitted from the base station (BS) on the satellite. Due to the relatively long propagation path between the satellite and the ground, the PSS experiences a long propagation delay. On the uplink transmission, the high Doppler frequency shift and the long propagation delay also occur with the NPRACH preamble signals transmitted from the user equipment (UE) toward the BS. The base station 101 often fails to receive any signal within the specified time of the receiving window and the specified frequency band; this therefore results in random access (RA) failure.

To mitigate or compensate for the above-mentioned effects, in this embodiment, the base station 101 includes a compensation unit to perform ‘pre-compensation’ and ‘post-compensation’. Referring to FIG. 1, in this embodiment, the base station 101 is exemplified by an on-satellite base station 101, which transmits communication beams toward the Earth's surface, covering a specific service area within a beam spot. In this embodiment, the working scenarios shown in FIG. 1 are adopted, and further analysis is conducted based on the parameter settings as shown in Table 1.

TABLE 1

| Parameters | Setting 1 | Setting 2 |
|---|---|---|
| Altitude | hₛₐₜ = 600 km | hₛₐₜ = 600 km |
| Payload | Regenerative | Regenerative |
| Operating band | S-band (2 GHz) | S-band (2 GHz) |
| Moving beams | Yes | Yes |
| Minimum | Spot Diameter | Spot Diameter |
| Elevation Angle | (km) | (km) |
| 30° (π/6 rad) | 144.02 | 256.91 |
| 45° (π/4 rad) | 82.10 | 153.63 |
| 90° (π/2 rad) | 46.23 | 92.70 |

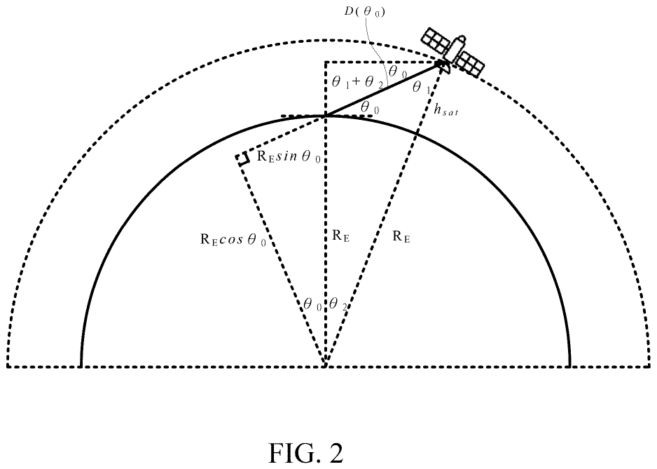

Since regenerative payloads are chosen in Settings 1 and 2, such payloads can operate as next-generation NodeBs (gNBs). FIG. 2 illustrates a geometric diagram of a Low Earth Orbit (LEO) working scenario for a communication system suitable for NTNs according to an exemplary embodiment of the present invention. Referring to FIG. 2, where the slant range is calculated based on the elevation angle of the UE. Using the auxiliary lines shown in the diagram, the slant range can be derived by applying the Pythagorean theorem, as expressed in Equation (1):

$$D ( {θ}_{0} ) = \sqrt{{( {R}_{E} + {h}_{sat} )}^{2} - {R}_{E}^{2} {cos}^{2} {θ}_{0}} - {R}_{E} sin {θ}_{0} \qquad ( 1 )$$

wherein R_{E}=6.371×10⁶ m represents the Earth's radius; hₛₐₜ represents the altitude of the serving satellite, and θ₀ denotes the elevation angle of the UE. After obtaining the path length between the user equipment and the satellite from Equation (1), the propagation delay can be calculated as:

$$T = \frac{D ( {θ}_{0} )}{C} ,$$

wherein C=3×10⁸ m/s represents the light speed.

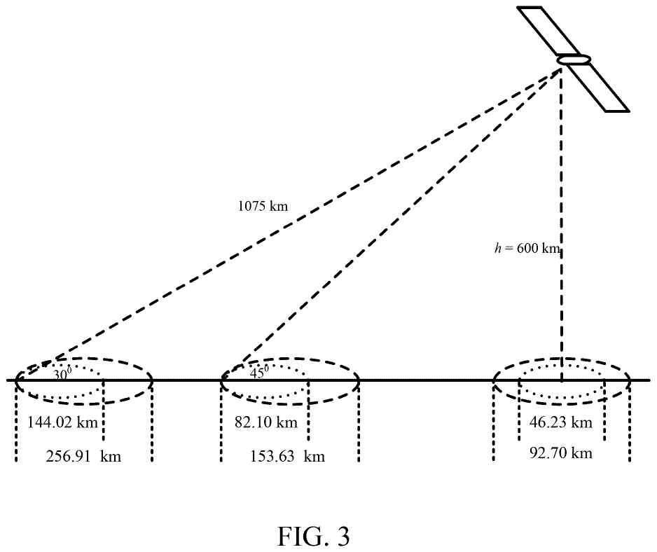

FIG. 3 illustrates a schematic diagram showing the relationship between the elevation angle and the beam spot size for a communication system suitable for NTNs according to an exemplary embodiment of the present invention. Referring to FIG. 3, using the Equation (1) above and the beam layout depicted in FIG. 3 and by iteratively applying the law of cosines, the maximum and minimum propagation delays within the beam spot can be calculated as listed in Table 2. Additionally, the maximum excess timing delays have been calculated and are also listed in Table 2. From the computed values in Table 2, a common delay can be calculated for the use in the aforementioned ‘pre-compensation’ and ‘post-compensation’ in the time domain. In this embodiment, the minimum propagation delay is designated as the common propagation delay for all UEs in a specific service area. Both TD pre- and post-compensations are carried out at the base station receiver on the satellite.

TABLE 2

| | Setting 1 | | | | Setting 2 | | | |
|---|---|---|---|---|---|---|---|---|
| | | Max. | Min. | Max. | | Max. | Min. | Max. |
| Minimum | Spot | Delay | Delay | Excess | Spot | Delay | Delay | Excess |
| Elevation | Diameter | Dₘₐₓ | Dₘᵢₙ | Delay | Diameter | Dₘₐₓ | Dₘᵢₙ | Delay |
| Angle | (km) | (ms) | (ms) | (μs) | (km) | (ms) | (ms) | (μs) |
| 30° (π/6 rad) | 144.02 | 3.5836 | 3.1770 | 406.67 | 256.91 | 3.5836 | 2.8741 | 709.5606 |
| 45° (π/4 rad) | 82.10 | 2.7160 | 2.5299 | 186.10 | 153.63 | 2.7160 | 2.3816 | 334.4198 |
| 90° (π/2 rad) | 46.23 | 2.0015 | 2.0000 | 1.4836 | 92.70 | 2.0061 | 2.0000 | 5.9583 |

By considering the geometric relations depicted in FIG. 2, the following equation is obtained:

$$\frac{( {R}_{E} + {h}_{sat} ) cos {θ}_{2} - {R}_{E}}{( {R}_{E} + {h}_{sat} ) sin {θ}_{2}} = tan {θ}_{0} . \qquad ( 2 )$$

Equation (2) can be reorganized into the following equation:

$$cos ( {θ}_{0} + {θ}_{2} ) = \frac{{R}_{E}}{{R}_{E} + {h}_{sat}} cos {θ}_{0} . \qquad ( 3 )$$

Therefore, θ₂ can be clearly expressed as a function of θ₀, and vice versa, as follows:

$${θ}_{2} = {cos}^{- 1} ( \frac{{R}_{E}}{{R}_{E} + {h}_{sat}} cos {θ}_{0} ) - {θ}_{0} , \qquad ( 4 )$$

$${θ}_{0} = {tan}^{- 1} ( cot {θ}_{2} - \frac{{R}_{E}}{{R}_{E} + {h}_{sat}} csc {θ}_{2} ) .$$

Thus, the Doppler frequency is calculated as follows:

$${f}_{D} = \frac{{V}_{s a t}}{\frac{C}{{f}_{c}}} cos ( {θ}_{0} + {θ}_{2} ) = \frac{{R}_{E}}{{R}_{E} + {h}_{sat}} {f}_{M} cos {θ}_{0} \qquad ( 5 )$$

wherein Vₛₐₜ=\sqrt{g·(R_{E}+hₛₐₜ)} is the instantaneous tangential velocity of the satellite; g=9.80665 m/s² is the gravitational acceleration;

$${f}_{M} = \frac{{V}_{sat}}{C / {f}_{c}}$$

is the maximum Doppler frequency; and f_{c} represents the carrier frequency.

Using Equation (5), the maximum and minimum Doppler frequencies within the beam spot can be calculated as listed in Table 3. From the calculated maximum and minimum Doppler frequencies in Table 3, a common Doppler shift can be calculated for the use in the aforementioned ‘pre-compensation’ and ‘post-compensation’ in the frequency domain (FD) on NPRACH reception in the on-satellite base station 101. In this embodiment, the algebraic average of the maximum and minimum Doppler frequencies is designated as the common Doppler shift.

TABLE 3

| Minimum | Setting 1 | | | | | Setting 2 | | | | |
|---|---|---|---|---|---|---|---|---|---|---|
| Elevation | Diameter | Maximum | Minimum | Mean | Residual | Diameter | Maximum | Minimum | Mean | Residual |
| Angle | (km) | (kHz) | (kHz) | (kHz) | (kHz) | (km) | (kHz) | (kHz) | (kHz) | (kHz) |
| 30° (π/6 rad) | 144.02 | 43.6126 | 41.5855 | 42.5991 | ±1.0136 | 256.91 | 43.6126 | 39.3746 | 41.4936 | ±2.1190 |
| 45° (π/4 rad) | 82.10 | 35.6096 | 32.7815 | 34.1955 | ±1.414 | 153.63 | 35.6096 | 29.7813 | 32.6954 | ±2.9142 |
| 90° (π/2 rad) | 46.23 | 1.9387 | −1.9387 | 0.0 | ±1.9387 | 92.70 | 3.8800 | −3.8800 | 0.0 | ±3.8800 |

For example, when the user equipment in FIG. 1 is located at the minimum elevation angle θ₀=30°, with the Earth's radius R_{E}=6.371×10⁶ m, satellite altitude hₛₐₜ=600 km=6×10⁵ m, satellite velocity Vₛₐₜ=8268.1 m/s. The user equipment's speed is undoubtedly much lower than the satellite's velocity and is thus neglected. Therefore, the Doppler frequency observed by the user equipment is:

$${f}_{D , max} = \frac{{V}_{s a t}}{\frac{C}{{f}_{c}}} \frac{{R}_{E}}{{R}_{E} + {h}_{sat}} cos {θ}_{0} = {f}_{c} \frac{{V}_{s a t}}{C} \frac{{R}_{E}}{{R}_{E} + {h}_{s a t}} cos {θ}_{0} = \frac{8268.1}{3 \times 1 {0}^{8}} \times \frac{6 \text{.371} \times {10}^{6}}{6.371 \times 1 {0}^{6} + 6 \times {10}^{5}} \times \frac{\sqrt{3}}{2} {f}_{c} = 2.18 \times 1 {0}^{- 5} {f}_{c} = 21.82 ppm of {f}_{c} .$$

As the carrier frequency is f_{c}=2 GHZ, the maximum Doppler frequency can be calculated as f_{D,max}=43.64 kHz. Besides, the round trip will double the value of Doppler frequency to 87.28 kHz. The subchannel bandwidth of NB-IoT is 3.75 kHz, while a group of 12 subchannels have a bandwidth of 45 kHz.

This level of Doppler frequency shift not only causes the spectra of the received signal to be displaced outside the designated frequency band, but also leads to significant intercarrier interference (ICI); therefore, making it difficult for an NPRACH receiver at a base station (BS) to correctly match, receive and then detect NPRACH preambles. Therefore, the present invention proposes to FD pre-compensate for the common Doppler shift before the base station (BS) transmits the primary synchronization signal (PSS) in order to reduce the impact caused by a Doppler frequency shift on the receiver. In this embodiment, the base station 101 performs pre-compensation on a per-beam-spot basis. This means that the compensation is conducted at the base station (BS), which serves all user equipments (UEs) and receives NPRACH preambles sent from any active UEs within the same service area. In this embodiment, the algebraic average of the highest and lowest Doppler frequencies within the beam spot is set as the common Doppler frequency, denoted as X. In this embodiment of the invention, since the base station (BS) can obtain the system parameters of the satellite, such as knowledge of the satellite's altitude, position, and the angle relative to the ground, as shown in the previously calculated values in Table 3, the common Doppler frequency X can be pre-determined and pre-stored.

For the sake of convenience in explanation, the actual Doppler frequency shift encountered during signal propagation is assumed to be X. Hence, the residual Doppler frequency shift, which is the actual Doppler frequency shift subtracted by the common Doppler frequency, depends on the location and elevant angle of the UE.

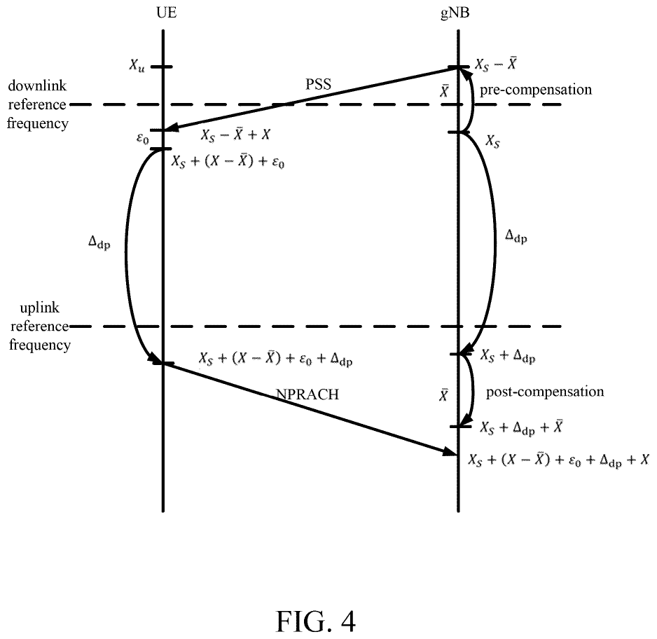

FIG. 4 illustrates an operational schematic diagram of pre-compensation and post-compensation in the frequency domain for downlink and uplink transmissions between a base station (BS) and a user equipment (UE) in an exemplary embodiment of the present invention. Referring to FIG. 4, according to the NB-IoT specification, the base station 101 needs to transmit the primary synchronization signal (PSS) within a fixed time interval. To address the high Doppler frequency shift, the base station 101 (gNB) first performs frequency pre-compensation on the PSS to be transmitted, adjusting its frequency band from the original downlink reference frequency designated in the specification by compensating for the common Doppler frequency X̅. Here, it is assumed that the base station 101 has a frequency error X_{S}, which results from instability of the local oscillator on the base station 101. Therefore, the frequency of the PSS broadcast by the base station 101 will become X_{S}−X̅. The common Doppler frequency X can be pre-calculated and pre-stored at the compensation unit in the base station 101 as a frequency-domain (FD) compensation parameter. Thus, the originally preset frequency band is adjusted to the pre-compensated frequency band using the frequency-domain (FD) compensation parameter. After passing through the non-terrestrial transmission channel, the frequency of the primary synchronization signal (PSS) on reception will be shifted to (X_{S}−X̅+X), where X represents the actual Doppler frequency shift.

After the user equipment (UE) receives the PSS, the local oscillator of the user equipment aligns its frequency and time with those of the received PSS. Assuming the alignment results in a frequency error ¿ at the user equipment (UE), the frequency at this point will be (X_{S}−X̅+X+ε), and the UE considers (X_{S}−X̅+X+ε) as the downlink reference frequency. According to the 3GPP specifications, NB-IoT uses the frequency-division duplex (FDD) method. The frequency separation between the downlink reference frequency and the uplink reference frequency is set to Δ_{dp}. Because the UE considers (X_{S}−X̅+X+ε) as the downlink reference frequency, the UE considers (X_{S}−X̅+X+8+Δ_{dp}) as the uplink reference frequency. Therefore, within the Random Access Opportunity (RAO), the user equipment will transmit the NPRACH preambles on a frequency band centered at (X_{S}−X̅+X+8+Δ_{dp}) to the base station 101.

Next, the signal containing the NPRACH preambles is transmitted to the base station 101, which is similarly affected by the Doppler frequency shift. The spectra of the signal received by the base station is centered at (X_{S}+(X−X̅)+ε+Δ_{dp}+X). In this embodiment, the base station 101 performs frequency post-compensation using the common Doppler frequency X. Here, using the frequency-domain (FD) compensation parameter (the common Doppler frequency X) pre-stored in the compensation unit within the base station 101, the originally predefined receive frequency band (X_{S}+Δ_{dp}), which the base station considers as the uplink reference, is adjusted to the post-compensated band (X_{S}+Δ_{dp}+X). After the post-compensation, the residual frequency error (RFE) on the NPRACH reception at the base station (BS) can be expressed as follows:

$$( {X}_{S} + ( X - \overline{X} ) + ε + {Δ}_{dp} + X ) - ( {X}_{S} + {Δ}_{dp} + \overline{X} ) = 2 ( X - \overline{X} ) + ε . \qquad ( 6 )$$

From the descriptions in FIG. 4, it can be seen that the residual frequency error (RFE) occurring with the NPRACH reception at the base station (BS) with assistance from the pre- and post-compensations can be calculated as 2(X−X̅)+E. In NTNs, the residual frequency errors (RFEs) generated during the NPRACH reception process have been calculated and are listed in Table 4. Additionally, the residual frequency errors (RFEs) obtained by compensating at the UE end in the prior art are shown in the rightmost column of Table 4, where X_{U} represents a frequency offset of a local oscillator at the UE, which is typically on the level of 1˜20 ppm of the carrier frequency, and 10 ppm is used in the rightmost column of Table 4. From Table 4, it can be seen that the residual frequency errors (RFEs) after applying the ‘pre-compensation’ and ‘post-compensation’ proposed in this embodiment are significantly lower than the residual frequency errors (RFEs) obtained by compensation at the UE end in the prior art.

TABLE 4

| Minimum | Setting 1 | | | Setting 2 | | | |
|---|---|---|---|---|---|---|---|
| Elevation | Diameter | 2(χ − χ̅) + ε | 2(χ − χ̅) ± ε | Diameter | 2(χ − χ̅) + ε | 2 (χ − χ̅) + ε | χ_{U} + ε |
| Angle | (km) | (kHz) | (Δf) | (km) | (kHz) | (Δf) | (kHz) |
| 30° (π/6 rad) | 144.02 | ±2.1772 | ±0.5806 | 256.91 | ±4.3880 | ±1.1701 | ±20.15 |
| 45° (π/4 rad) | 82.10 | ±2.9780 | ±0.7941 | 153.63 | ±5.9784 | ±1.5942 | ±20.15 |
| 90° (π/2 rad) | 46.23 | ±4.0274 | ±1.0740 | 92.70 | ±7.9100 | ±2.1093 | ±20.15 |

As explained above, after the ‘pre-compensation’ and ‘post-compensation’ of the frequency, the residual frequency error (RFE) on the NPRACH reception at the base station is significantly reduced. Furthermore, in this embodiment, both the ‘pre-compensation’ and ‘post-compensation’ are performed at the base station on the satellite. For the user equipment, only the operations originally designed for terrestrial network (TN) user equipment (UE) are required to work, i.e. synchronizing its own local oscillator with respect to the received PSS, and then transmitting the NPRACH preambles in accordance with the specification. Therefore, the user equipment does not know whether the received PSS is broadcast from a TN base station or from an NTN base station. As a result, the base station (gNB) in the non-terrestrial network performs pre-compensation on its transmitted signal using the common Doppler frequency and post-compensate the receive band by the common Doppler frequency without modification at the UE end. The proposed RA process maintains backward compatibility with the terrestrial network as specified in the 3GPP specifications. It is not necessary to require UE to be equipped with GNSS or GPS capability, which approximately takes 34%˜45% of UE's total power consumption, requires high computational complexity, and unavoidably takes double hardware complexity for antennas and radio-frequency (RF) circuitry at the UE device.

Another major challenge in non-terrestrial network (NTN) communications is long propagation delays. According to the calculation in Equation (1) and the results listed in Table 2, the maximum and minimum propagation delays occur at elevation angles of 30° and 90°, with propagation delays of 3.58 ms and 2.00 ms, respectively. These propagation delays are even longer than the length of a subframe (i.e., 2 ms). To mitigate the propagation delays in NTN, this embodiment proposes ‘pre-compensation’ and ‘post-compensation’ in the time domain, which are performed both at the base station 101.

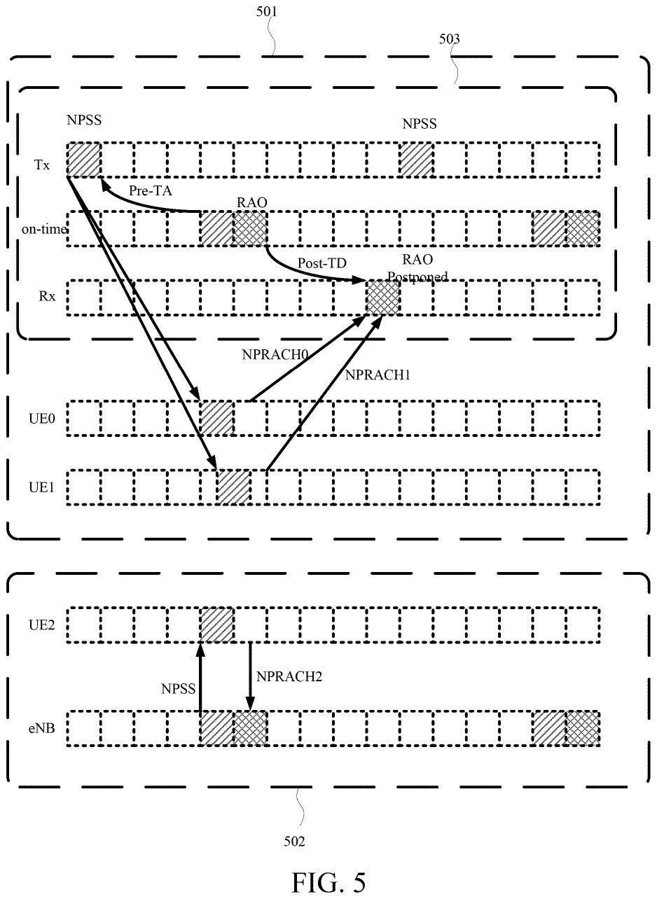

FIG. 5 illustrates an operational schematic diagram of “pre-compensation” and “post-compensation” in the time domain for a communication system suitable for non-terrestrial networks (NTNs) according to an exemplary embodiment of the present invention. Referring to FIG. 5, label 501 represents the time-domain (TD) operation diagram of the non-terrestrial network in this exemplary embodiment; label 502 represents the time-domain (TD) operation diagram of a terrestrial network as specified by 3GPP; and label 503 represents the time-domain operation diagram of the base station in the non-terrestrial network according to this exemplary embodiment. In this embodiment, a frame of the downlink signal includes 10 subframes, each with a length of 1 ms, and each subframe is further composed of two slots, each being of 0.5 ms in length. The narrowband primary synchronization signal (NPSS) is located in the sixth subframe and is broadcast once per frame. When the base station 101 on the satellite broadcasts the NPSS to all user equipments (UEs) within the beam spot, a pre-time advance (Pre-TA) is applied before the downlink transmission. Referring to the time-domain operation diagram 503 for the non-terrestrial network base station, the actual transmitted sequence (marked as Tx), the actual received sequence (marked as Rx), and the standard specific sequence (marked as on-time) are indicated. These time sequences are typically implemented in hardware using shift registers. In this embodiment, it can be seen that the time at which the NPSS should be transmitted in the standard specific time sequence (marked as on-time) is advanced by the TD pre-compensation parameter as shown in the actual transmitted sequence (Tx). The user equipment UE0 and UE1 receive the subframe conveying the NPSS, which is close to that in the standard specific time sequence (marked as on-time). After receiving the NPSS, the user equipment UE0 and UE1 can transmit the NPRACH preambles, NPRACH0 and NPRACH1, in the next subframe. Referring to the standard specific time sequence (marked as on-time), this period corresponds to the Random Access Opportunity (RAO). The propagation delay will unavoidably occur with the NPRACH preambles that are transmitted by the user equipments, UE0 and UE1. Therefore, in this embodiment, the Random Access Opportunity (RAO) in the base station must be postponed (also known as Post-TD) by the common delay. Therefore, the NPRACH preambles, NPRACH0 and NPRACH1, arrive at the base station in the postponed receiving time window.

In this embodiment, the lengths of Pre-TA and Post-TD are both set as a common delay. In this embodiment, the common delay is, for example, set to the minimum propagation delay Dₘᵢₙ within the beam spot. Since the satellite's altitude, position, and the angle relative to the ground are known by the base station 101 on the satellite, as shown in the pre-calculated Table 2, the base station 101 can determine the above-mentioned common delay before transmission of PSS. Although, in the above embodiment, the lengths of Pre-TA and Post-TD are set to an identical value that is the common delay Dₘᵢₙ, i.e., the minimum propagation delay within the beam spot, people having ordinary skills in the art would understand that the present invention is not limited thereto. The lengths of Pre-TA and Post-TD could also, for example, be the arithmetic average of the maximum and minimum propagation delays. In addition, people having ordinary skills in the art would understand that the present invention does not restrict the lengths of Pre-TA and Post-TD to be integer multiples of the slot length or subframe duration.

The RA procedure begins after the user equipment (UE) acquires the PSS. The signal from the base station 101 on the satellite must undergo pre-time advance (Pre-TA) to compensate for the common delay Dₘᵢₙ. The PSS received by user equipments UE0 and UE1 may be delayed. Each user equipment independently estimates the time and frequency of the received PSS, and then synchronizes its local oscillator with respect to the received PSS. Therefore, as shown in the diagram, the time instants at which user equipments UE0 and UE1 transmit the NPRACH preambles NPRACH0 and NPRACH1 may be different. Typically, this process time is shorter than the duration of a subframe. Then, user equipments UE0 and UE1 will transmit their NPRACH preambles, NPRACH0 and NPRACH1, in the following subframe, which is considered as RAO by UEs.

Next, refer to the actual received sequence Rx in the base station's time-domain operation diagram 503. In the base station's reception sequence on the satellite, the receiving windows for RAO have been postponed by a common delay Dₘᵢₙ. The preambles NPRACH0 and NPRACH1, encountering propagation delays, can arrive at the base station on the satellite within the receiving window of RAO that is the post-TD RAO.

Next, as shown in the lower half of FIG. 5, compare with the time-domain operation diagram 502 of the 3GPP TN. User equipment UE2 receives the PSS broadcast from the TN base station, denoted as eNB, and then sends the NPRACH preambles, denoted as NPRACH2, to the TN base station eNB in the next subframe. In the time-domain (TD) perspective, the technique proposed in the preferred embodiment of the present invention still maintains backward compatibility with 3GPP TN. It is notable that the pre-time advance (pre-TA) achieved by the common delay Dₘᵢₙ can be considered as the delay of the narrowband primary synchronization signal (NPSS) transmission by (10 ms−Dₘᵢₙ), as the narrowband primary synchronization signal (NPSS) is broadcast periodically every 10 ms, which is also the length of the 5G NR frame duration in non-terrestrial networks (NTNs). Meanwhile, the random access opportunity (RAO) postponement should be realized by postponing the random access opportunity (RAO) window by (10 ms+Dₘᵢₙ). Notably, for transparent payloads, such as when a satellite operates as an analog RF repeater, the propagation delay and Doppler shift in the feeder link between the gateway base station on the ground and the satellite can be compensated or adjusted by the gateway base station on the ground. The compensation method can also be done by pre-calculating and pre-storing the values at the gateway base station on the ground, but the compensation will involve the time and frequency compensations for both feeder link (i.e., from the gateway base station on the ground to the satellite) and service link (i.e., from the satellite to the user equipment). The gateway base station has strong computational capabilities, real-time ephemeris data, beam-satellite geometric information, strong power supply and high-precision local oscillators to conduct the time-domain and frequency-domain pre-compensations and post-compensations.

The above embodiment ensures that: 1. The PSS transmitted by the base station 101 can be received by a user equipment (UE) within its service area within the specified time (e.g., according to the 5G network standard). 2. The base station 101, after adjusting the post-compensated time and post-compensated frequency, will receive NPRACH preambles transmitted from user equipments within its service area. After the above-mentioned time-domain and frequency-domain pre-compensations and post-compensations are completed, different residual frequency errors (RFEs) and different residual time errors (RTEs) occur with NPRACH preambles transmitted from individual UEs and arriving at the base station because the locations of UEs in the service area are different.

For the convenience of explanation of this embodiment, the baseband equivalent signal transmitted by the u-th user equipment is expressed in the discrete-time representation as follows:

$${s}_{u}^{′} [ k ] = \sqrt{{P}_{s}} {e}^{j \frac{2 π v [ u , l , m ] k}{N}} \qquad ( 7 )$$

In this case, k represents the time index, which represents sampling at instant ktₛ, where tₛ is the sampling period; and

$${t}_{s} = \frac{T}{N} ,$$

where T is the symbol duration and N represents the number of samples within one symbol,

$${P}_{s} = \frac{{E}_{s}}{{t}_{s}}$$

represents the signal power, where Eₛ is the energy of the signal in a sample duration. v[u, l, m] represents the normalized subcarrier frequency used in the m-th symbol group (SG) of the l-th preamble sent from the u-th user equipment. For simplicity, we use v to represent v[u, l, m] hereafter unless the variables u, l, m matter in an expression.

The superimposed signal received at the base station can be expressed as:

$$r [ k ] = \frac{{r}^{′} [ k ]}{\sqrt{{P}_{s}}} = {\sum }_{u = 0}^{U - 1} {w}_{u , k} {s}_{u} [ k - {l}_{u} ] {e}^{j ( 2 π \frac{{ϵ}_{u} ( k - {l}_{u} )}{N} + {ϕ}_{u , 0} )} + n [ k ] , \qquad ( 8 )$$

$$k = 0 , 1 , 2 , …$$

$${r}^{′} [ k ] = {\sum }_{u = 0}^{U - 1} {w}_{u , k} {s}_{u}^{′} [ k - {l}_{u} ] {e}^{j ( 2 π \frac{{ϵ}_{u} ( k - {l}_{u} )}{N} + {ϕ}_{u , 0} )} + {n}^{′} [ k ] ;$$

$${s}_{u} [ k ] = \frac{{s}_{u}^{′} [ k ]}{\sqrt{{P}_{s}}} , n [ k ] = \frac{{n}^{′} [ k ]}{\sqrt{{P}_{s}}} ;$$

w_{u,k} represents the complex-valued channel gain, ϵᵤ represents the normalized frequency error, lᵤ represents the time error occurring in the uplink of the u-th user, and φ_{u,0} represents the initial phase error caused by the front-end non-coherent downconversion process. For simplicity, the above equation is power-normalized using

$$\frac{1}{\sqrt{{P}_{s}}} .$$

The normalized frequency error ϵᵤ in Equation (8) is the residual frequency error normalized by the subchannel bandwidth (also called the subcarrier spacing)

$$Δ f = \frac{1}{T} ,$$

and is defined as

$${ϵ}_{u} = \frac{{ε}_{u}}{Δ f} ,$$

where εᵤ represents the residual frequency error of the u-th uplink and its unit is Hertz (Hz). The value of εᵤ has been calculated and is listed in the third and sixth columns of Table 4, while the normalized frequency error ϵᵤ has also been calculated and is listed in the fourth and seventh columns of Table 4. n′[k]=n′(ktₛ) represents the additive white Gaussian noise (AWGN) sampled at time instant ktₛ from n′(t), with a power spectral density (PSD) of Sₙ(f)=N₀. The null-to-null bandwidth of the receive filter here is

$$\frac{1}{{t}_{s}} ,$$

and the sampled noise n′[k] is an uncorrelated Gaussian sequence with a mean of zero and a variance of

$$2 {σ}_{n}^{2} = \frac{{N}_{0}}{{t}_{s}} .$$

Due to the normalization relationship

$$n [ k ] = \frac{1}{\sqrt{{P}_{s}}} {n}^{′} [ k ] ,$$

n[k] is an uncorrelated Gaussian sequence with a mean of zero and a variance of

$$2 {\overline{σ}}_{n}^{2} = \frac{2 {σ}_{n}^{2}}{{P}_{s}} = {( \frac{{E}_{s}}{{N}_{0}} )}^{- 1} .$$

For the u-th user equipment (UE), the received signal in Equation (8) can be rewritten as:

$$r [ k ] = {\sum }_{{u}^{′} = 0}^{U - 1} {w}_{{u}^{′} , k} {s}_{{u}^{′}} [ k - {l}_{{u}^{′}} ] {e}^{j ( 2 π \frac{{ϵ}_{{u}^{′}} ( k - {l}_{{u}^{′}} )}{N} + {ϕ}_{{u}^{′} , 0} )} + n [ k ] = {w}_{u , k} {s}_{u} [ k - {l}_{u} ] {e}^{j ( 2 π \frac{{ϵ}_{u} ( k - {l}_{u} )}{N} + {ϕ}_{u , 0} )} + {n}_{ι} [ k ] \qquad ( 9 )$$

where the former term represents the preamble sent from the u-th user equipment, which is the desired signal term, and the latter term nₜ[k] is written as:

$${n}_{ι} [ k ] = ι [ k ] + n [ k ] .$$

This expression includes an intercarrier interference (ICI) term, which is represented as:

$$ι [ k ] = {\sum }_{\begin{matrix}{u}^{′} = 0 \\ {u}^{′} \neq u\end{matrix}}^{U - 1} {w}_{{u}^{′} , k} {s}_{{u}^{′}} [ k - {l}_{{u}^{′}} ] {e}^{j ( 2 π \frac{{ϵ}_{{u}^{′}} ( k - {l}_{{u}^{′}} )}{N} + {ϕ}_{{u}^{′} , 0} )} .$$

The term n[k] represents an AWGN with zero mean anu variance

$$2 {\overline{σ}}_{n}^{2} .$$

The intercarrier interference (ICI) primarily comes from adjacent sub-channels, and there is no explicit analytical model for it. The following analysis mainly focuses on the impact of the AWGN term. When the channel gain w_{u,k} and initial phase Puo are considered as nuisance (or undesired) parameters, the likelihood function and the log-likelihood function of ϵᵤ and lᵤ of the u-th uplink can be written as follows:

$$\tilde{L} ( ( \begin{matrix}{ϵ}_{u} \\ {l}_{u}\end{matrix} ) ; {w}_{u , k} , {ϕ}_{u , 0} ) = {\prod }_{k = 0}^{N - 1} \frac{1}{2 π {\overline{σ}}_{n}^{2}} {e}^{\frac{{\vert r [ k ] - {w}_{u , k} {e}^{j ( \frac{2 π}{N} ( v + {ϵ}_{u} ) ( k - {l}_{u} ) + {ϕ}_{u , 0} )} \vert}^{2}}{2 {\overline{σ}}_{n}^{2}}} = {( 2 π {\overline{σ}}_{n}^{2} )}^{- N} exp ( - \frac{{\sum }_{k = 0}^{N - 1} {\vert r [ k ] - {w}_{u , k} {e}^{j ( \frac{2 π}{N} ( v + {ϵ}_{u} ) ( k - {l}_{u} ) + {ϕ}_{u , 0} )} \vert}^{2}}{2 {\overline{σ}}_{n}^{2}} ) . \qquad ( 10 )$$

$$L ( ( \begin{matrix}{ϵ}_{u} \\ {l}_{u}\end{matrix} ) ; {w}_{u , k} , {ϕ}_{u , 0} ) = - N log ( 2 π {\overline{σ}}_{n}^{2} ) - \frac{1}{2 {\overline{σ}}_{n}^{2}} {\sum }_{k = 0}^{N - 1} {\vert r [ k ] - {w}_{u , k} {e}^{j ( \frac{2 π}{N} ( v + {ϵ}_{u} ) ( k - {l}_{u} ) + {ϕ}_{u , 0} )} \vert}^{2} . \qquad ( 11 )$$

As a result, the joint maximum likelihood estimation (JMLE) of ϵᵤ and lᵤ with the nuisance parameters w_{u,k} and φ_{u,0} can be written as:

$$[ \begin{matrix}{\hat{ϵ}}_{u} \\ {\hat{l}}_{u}\end{matrix} ] arg {max}_{{ϵ}_{u} , {l}_{u}} L ( ( \begin{matrix}{ϵ}_{u} \\ {l}_{u}\end{matrix} ) ; {w}_{u , k} , {ϕ}_{u , 0} ) = arg {max}_{{ϵ}_{u} , {l}_{u}} \vert {w}_{u , k} \vert \vert {\sum }_{k = 0}^{N - 1} r [ k ] {e}^{- j ( \frac{2 π}{N} ( v + {ϵ}_{u} ) ( k - {l}_{u} ) )} \vert \cdot ℜ \{ {e}^{- j ( {ϕ}_{u , 0} + {ϕ}_{w} - {ϕ}_{c} )} \} = arg {max}_{{ϵ}_{u} , {l}_{u}} \vert κ ( {ϵ}_{u} , {l}_{u} ) \vert \qquad ( 12 )$$

where [symbol] {⋅} denotes the operation of taking the real part of argument; and

$$κ ( {ϵ}_{u} , {l}_{u} ) = {\sum }_{k = 0}^{N - 1} r [ k ] {e}^{- j ( \frac{2 π}{N} ( v + {ϵ}_{u} ) ( k - {l}_{u} ) )}$$

represents the cross-correlation of the received signal and a replica of a symbol in the preamble with a frequency shift ϵᵤ and a time error lᵤ; and

$${ϕ}_{w} = {tan}^{- 1} \frac{𝔍 \{ {w}_{u , k} \}}{ℜ \{ {w}_{u , k} \}} =$$

$${ϕ}_{c} = {tan}^{- 1} \frac{𝔍 \{ {\sum }_{k = 0}^{N - 1} r [ k ] {e}^{- j ( \frac{2 π}{N} ( v + {ϵ}_{u} ) ( k - {l}_{u} ) )} \}}{ℜ \{ {\sum }_{k = 0}^{N - 1} r [ k ] {e}^{- j ( \frac{2 π}{N} ( v + {ϵ}_{u} ) ( k - {l}_{u} ) )} \}} ,$$

with [symbol] {⋅} denoting the operation of taking the imaginary part of argument.

It is noted that the |w_{u,k}| and [symbol] {e^{-j(φ}^{_{u,0}}^{+φ}^{_{w}}^{-φ}^{_{c}}⁾} in Equation (12) do not contain the parameters ϵᵤ and lᵤ; therefore being irrelevant to the peak search of the likelihood function of ϵᵤ and lᵤ. As a result, the joint maximum-likelihood estimator (JMLE) of ϵᵤ and lᵤ should be developed via a bank of symbol-level correlators (SLCs). The output of the symbol-level correlator (SLC) can be expressed as follows:

$$ξ ( {\hat{ϵ}}_{u} , {\hat{l}}_{u} ) = \frac{1}{N} {\sum }_{k = 0}^{N - 1} r [ k ] {e}^{- j ( \frac{2 π}{N} ( v + {\hat{ϵ}}_{u} ) ( k - {\hat{l}}_{u} ) )} \qquad ( 13 )$$

where \hat{ϵ}ᵤ represents the estimate of the residual frequency error ϵᵤ, and \hat{l}ᵤ represents the estimate of the residual time error lᵤ in the u-th uplink.

The Joint Maximum Likelihood Estimation (JMLE) is searching for \hat{ϵ}ᵤ and lᵤ that arrive at the maximum of the log-likelihood function. The peak of |ξ(\hat{ϵ}ᵤ, \hat{l}ᵤ)| occurs at the maximum of the log-likelihood function in accordance with Equation (12). In this embodiment, for example, symbol-level correlation, written as in Equation (13), is used to implement the aforementioned JMLE.

When applied to the q-th symbol of the m-th symbol group of the/-th preamble sent from the u-th user equipment device, the symbol-level correlator (SLC) output can be expressed as:

$${ξ}_{l , m , q} ( {\hat{ϵ}}_{u} , {\hat{l}}_{u} ) = \frac{1}{N} {\sum }_{k = m {N}_{S G} + q N + {N}_{c p}}^{m {N}_{S G} + q N + {N}_{c p} + ( N - 1 )} r [ k ] {e}^{- j 2 π ( \frac{( v + {\hat{ϵ}}_{u} ) ( k - {\hat{l}}_{u} )}{N} )} = {C}_{l , m , q} ( {\hat{ϵ}}_{u} , {\hat{l}}_{u} ) + {I}_{l , m , q} + {n}_{l , m , q} , \qquad ( 14 )$$

$$m = 0 , 1 , 2 , 3 ; q = 0 , 1 , 2 , 3 , 4$$

where C_{l,m,q}(\hat{ϵ}ᵤ \hat{l}ᵤ) is the desired term; I_{l,m,q} represents the ICI term; n_{l,m,q} represents the noise term; and N_{cp} and N_{SG} represent the number of samples in the cyclic prefix (CP) and the number of samples per symbol group (SG), respectively.

The desired term C_{l,m,q} (\hat{ϵ}ᵤ, \hat{l}ᵤ) can be expressed as:

$${C}_{l , m , q} ( {\hat{ϵ}}_{u} , {\hat{l}}_{u} ) = {w}_{u , k} {e}^{j {ϕ}_{u , 1}} {e}^{j \frac{π ( {ϵ}_{u} - {\hat{ϵ}}_{u} )}{N} ( m {N}_{S G} + q N + {N}_{c p} + ( N - 1 ) )} \cdot \frac{sin ( π ( {ϵ}_{u} - {\hat{ϵ}}_{u} ) )}{N sin ( \frac{π ( {ϵ}_{u} - {\hat{ϵ}}_{u} )}{N} ) .}$$

The ICI term I_{l,m,q} can be expressed as:

$${l}_{l , m , q} = \frac{1}{N} {\sum }_{k = m {N}_{S G} + q N + {N}_{c p}}^{m {N}_{S G} + q N + {N}_{c p} + ( N - 1 )} {\sum }_{{{u}^{′} = 0}_{{u}^{′} \neq u}}^{U - 1} {w}_{{u}^{′} , k} \cdot {e}^{j 2 π ( \frac{( v + {ϵ}_{{u}^{′}} ) ( k - {l}_{{u}^{′}} )}{N} )} {e}^{- j 2 π ( \frac{( v + {\hat{ϵ}}_{u} ) ( k - {\hat{l}}_{u} )}{N} )}$$

From the above equation, the ICI term I_{l,m,q} predominantly results from mismatch between ϵᵤ′ and \hat{ϵ}ᵤ as well as misalignment between lᵤ′ and \hat{l}ᵤ.

For the noise term, assuming it is AWGN, the derivation details are omitted.

Through the above SLC method, the likelihood measure calculated over L preambles can be expressed as the accumulation of the squared magnitudes of the SLC outputs, as follows:

$${X}_{u , L} ( {\hat{ϵ}}_{u} , {\hat{l}}_{u} ) = {\sum }_{l = 0}^{L - 1} {ζ}_{l} ( {\hat{ϵ}}_{u} , {\hat{l}}_{u} ) \qquad ( 15 )$$

$$where$$

$${ζ}_{l} ( {\hat{ϵ}}_{u} , {\hat{l}}_{u} ) = {\sum }_{m = 0}^{3} {\sum }_{q = 0}^{4} {\vert {ξ}_{l , m , q} ( {\hat{ϵ}}_{u} , {\hat{l}}_{u} ) \vert}^{2} .$$

By inputting possible \hat{ϵ}ᵤ and \hat{l}ᵤ for the u-th user equipment, a likelihood measure X_{u,L}(\hat{ϵ}ᵤ, \hat{l}ᵤ) can be obtained. When at least one of the likelihood measures {X_{u,L}(\hat{ϵ}ᵤ, \hat{l}ᵤ); ∀\hat{ϵ}ᵤ, ∀\hat{l}ᵤ} exceeds a preset threshold, it indicates that the u-th user equipment is highly probable to be active. The \hat{ϵ}ᵤ and \hat{l}ᵤ achieving the maximum value among all likelihood measures {X_{u,L}(\hat{ϵ}ᵤ, \hat{l}ᵤ); ∀\hat{ϵ}ᵤ, ∀\hat{l}ᵤ} are the joint ML estimates of the residual frequency error (RFE) ϵᵤ and the residual time error (RTE) \hat{l}ᵤ. The base station sends a random access response conveying the estimates \hat{ϵ}ᵤ and \hat{l}ᵤ to the u-th user equipment, which is considered active.

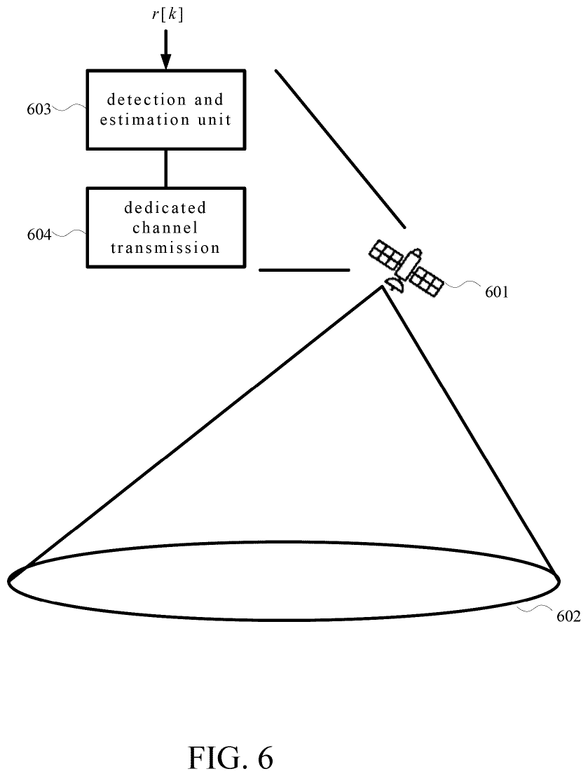

As described above, FIG. 6 illustrates a system block diagram of a communication system suitable for non-terrestrial networks (NTNs) according to an exemplary embodiment of the present invention. Referring to FIG. 6, in this embodiment, the NTN communication system is similarly exemplified using the current 5-th Generation (5G) wireless communication network, and Narrowband Internet of Things (NB-IoT) is used as an example. This NTN communication system includes a base station 601 and a service area 602. It is assumed that this service area 602 includes a number of Narrowband IoT user equipment devices. The base station 601 is also exemplified as base station on a satellite. This base station 601 includes a detection and estimation unit 603, a dedicated channel transmission 604 and a compensation unit (not depicted). The compensation unit is used to compensate for a common Doppler frequency and a common delay, and the work of the compensation unit has been clearly described in the aforementioned FIG. 4 and FIG. 5.

The base station 601 is used to open the receiving window during a specified time, such as the post-compensated frequency band and post-compensated time (as described above), in order to receive a received signal r[k]. The detection and estimation unit 603 receives the aforementioned received signal r[k] and performs a two-dimensional correlation function calculation for the multiple user equipments that send random access preambles to the base station 601. In prior arts, the base station 601 would perform a single fast Fourier transform (FFT) calculation for the multiple user equipment that could be accessed, to determine whether the corresponding user equipment has sent a random access request. However, the signal received at the base station 601 in this NTN communication system is severely affected by the Doppler effect. The signal transmitted from the NB-IoT UE devices suffers from high Doppler frequency shift and long propagation delay, the spectra of the received signal may be moved into out-of-band (non-compliant) channels, meanwhile the time-of-arrival (ToA) of the received signal may be late severely beyond random access opportunity. Moreover, the Doppler frequency may not be integer multiples of the subcarrier spacing; therefore, not only resulting in significant intercarrier interference (ICI) but also ruining cross correlation between the received signal and locally generated NPRACH preambles. Therefore, simply using a single FFT demodulator without frequency-domain upsampling as in prior techniques cannot effectively acquire any NPRACH preamble to determine whether a user equipment is in an active state.

To extend the range of RTE estimation, the detection and estimation unit 603 of the present invention is configured as a rake structure, in which each arm corresponds to an RTE candidate. To extend the range of RFE estimation, each arm of the rake structure conveys a bank of symbol-level correlators (SLCs), in which each SLC corresponds to an RFE candidate. Furthermore, one bank of SLCs on a rake arm is realized using an FFT demodulator. To reduce complexity, a time-domain (TD) downsampling method is used. To increase the RFE estimation accuracy, a frequency-domain (FD) upsampling method is realized by zero-padding with the input sequence, which is the TD downsampled sequence, of the FFT demodulator. Therefore, the RFE and RTE are estimated with precision on the levels of a fraction of the subcarrier spacing and a fraction of the symbol duration, respectively, via a grid search method. As a result, the present invention realizes the joint maximum estimator of RFE and RTE with high precisions and with extended ranges in both the frequency and the time domains.

In this embodiment, by using the aforementioned two-dimensional correlation function calculation, multiple likelihood measures are calculated for a user equipment, based on multiple candidates for the residual frequency error (RFE) and multiple candidates for the residual time error (RTE). This allows the accumulation of the squared absolute-value measurements of the spectral bins to correspond to the likelihood measures for the user equipment.

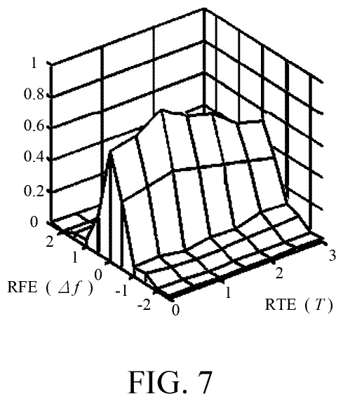

FIG. 7 illustrates a simulation diagram of likelihood measures for a UE in a communication system suitable for non-terrestrial networks (NTNs) according to an exemplary embodiment of the present invention. Referring to FIG. 7, the X-axis represents candidates of residual frequency error, the Y-axis represents candidates of residual time error, and the Z-axis represents the likelihood measures for the UE. If at least one of the plurality of the likelihood measures corresponding to a specific UE exceeds a preset threshold, it indicates that the UE is active. In such a case, a random access response (RAR) can be sent to the user equipment. This significantly reduces the miss probability of the NPRACH at the base station 601 and increases the access success rate for user equipment. The dedicated channel transmission 604 communicates with the detection and estimation unit 603 and is configured to send a response, such as a random access response (RAR) message, to the user equipment identified as active. If none of the likelihood measures for a user equipment exceeds the preset threshold, the detection and estimation unit 603 determines that the user equipment is inactive, and no random access response (RAR) will be sent.

Additionally, in a further preferred embodiment, the detection and estimation unit 603 identifies the maximum value from the multiple likelihood measures of the user equipment in an active state. Specifically, the detection and estimation unit 603 performs peak search among all likelihood measures based on the candidates of the residual frequency error and residual time error and obtains the corresponding estimates of residual frequency error and residual time error for the user equipment. At this point, the base station 601 sends the estimates of residual frequency error and residual time error to the corresponding user equipment through the dedicated channel transmission 604. As a result, the user equipment can adjust its local oscillator using the received estimates of residual frequency error and residual time error, thereby reducing ICI, reducing miss and false-alarm probabilities on NPRACH reception at the base station, and ultimately improving the communication performance and robustness.

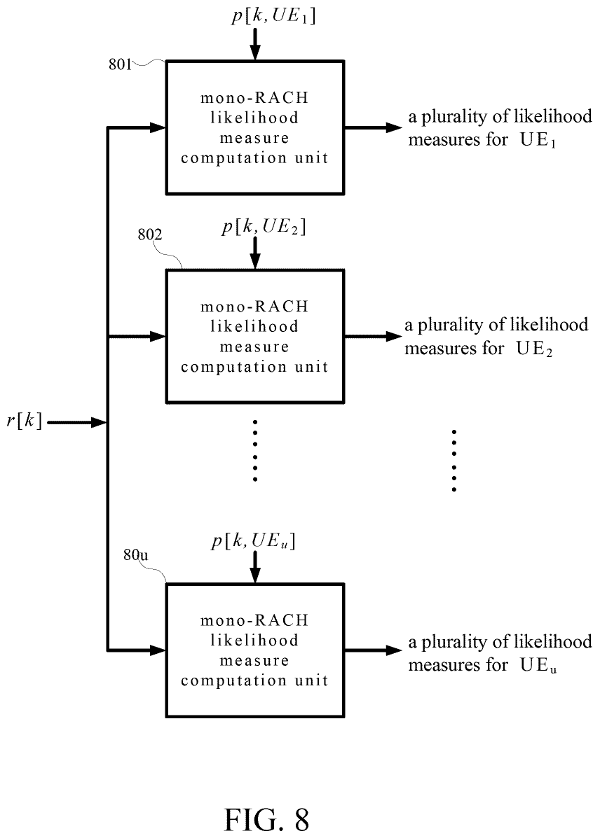

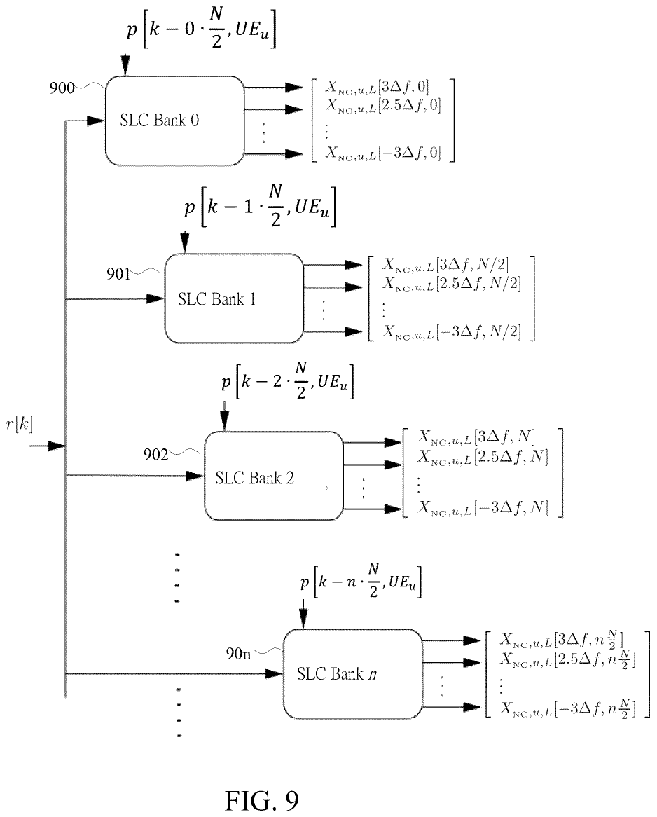

FIG. 8 illustrates a block diagram of the detection and estimation unit 603 for a communication system suitable for non-terrestrial networks (NTNs) according to an exemplary embodiment of the present invention. Referring to FIG. 8, in this embodiment, the detection and estimation unit 603 includes multiple mono-random access channel (mono-RACH) likelihood measure computation units 801, 802, . . . 80u. In this embodiment, the first mono-RACH likelihood measure computation unit 801 receives the received signal r[k] and the preambles p[k, UE₁] corresponding to the first random access channel preambles. The u-th mono-RACH likelihood measure computation unit 80u receives the received signal r[k] and the preambles p[k, UEᵤ] corresponding to the u-th random access channel preambles. Meanwhile, the u-th mono-RACH likelihood measure computation unit 80u is depicted in FIG. 9. The preamble p[k, UEᵤ] can be regarded as an important criterion for determining whether the u-th user equipment has accessed the network. The user equipment selects a preamble randomly from a set of available preambles based on a certain random algorithm. Therefore, in this embodiment, the preamble p[k, UEᵤ] is used as the input for the u-th mono-RACH likelihood measure computation unit 80u, and a correlation function calculation is performed using the received signal r[k] and the preamble p[k, UEᵤ]. This allows the determination of whether the u-th user equipment is in an active state.

According to the derivations of Equations (13)-(15) in the above, a bank of SLCs with various candidates of RFE is recommended. To improve the estimation accuracy, the RFE candidates can be chosen as equally spaced by a fraction of the subcarrier spacing Δf, while the RTE candidates can be chosen as ones equally spaced by a fraction of the symbol duration T. Therefore, the JMLE is converted to a grid search procedure.

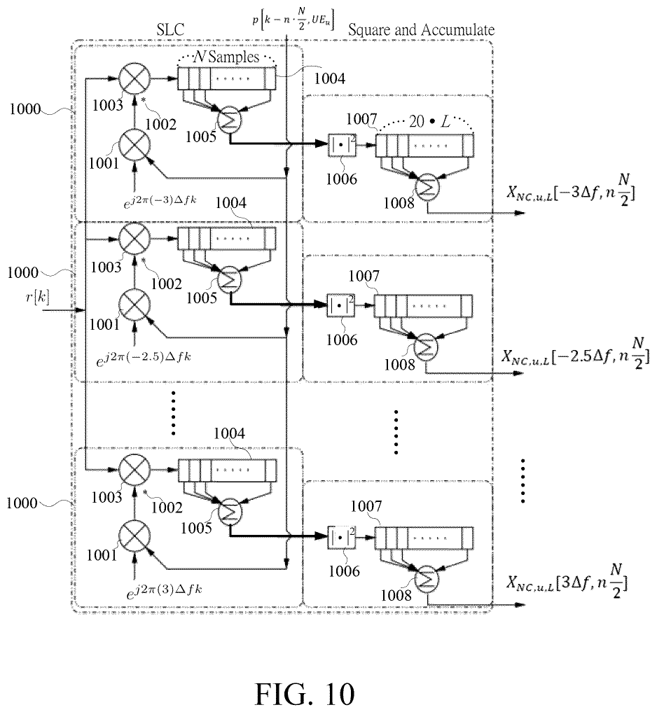

The detection metric over L preambles can be formulated as the accumulation of the squared magnitudes of the SLC outputs and is the likelihood measure X_{u,L}(\hat{ϵ}ᵤ, tu) as written in Equation (15). The corresponding joint estimator for UEᵤ can be directly developed as an extended fractionally spaced 2D array of mono-RACH SLCs as depicted in FIG. 9, where the n-th SLC bank is depicted in FIG. 10. As shown in FIG. 9, to extend the range of the RTE estimation, the proposed technique employs a rake structure, in which each arm corresponds to an RTE candidate. To extend the range of the RFE estimation, each arm of the rake receiver conveys a bank of SLCs, as shown in FIG. 10, in which each SLC corresponds to an RFE candidate. The advantage of the joint estimation subsystem in FIG. 9 is that it is easy to realize and straightforward. In addition, the separation of RFE candidates is tunable, and is not necessary to be integer multiples of the subcarrier spacing; while the separation of RTE candidates is also tunable, and is not necessary to be shorter than one CP length. However, it has high computational and hardware complexity as the number of UEs increases and has no flexibility for FD oversampling to improve the estimation accuracy.

FIG. 9 illustrates a block diagram of the u-th mono-RACH likelihood measure computation unit 80u for UEᵤ in a communication system suitable for non-terrestrial networks (NTNs) according to an exemplary embodiment of the present invention. Referring to FIG. 9, where the u-th mono-RACH likelihood measure computation unit 80u includes multiple symbol-level correlator banks (SLC banks) 900, 901, 902, . . . 90n. Each symbol-level correlator bank 900 to 90n has its first input terminal receiving the received signal r[k]. The second input terminal of the 0-th symbol-level correlator bank 900 receives the preamble p[k, UEᵤ] with no delay. The second input terminal of the first symbol-level correlator bank 901 receives the preamble

$$p [ k - 1 \cdot \frac{N}{2} , {UE}_{u} ] ,$$

which is p[k, UEᵤ] delayed by one unit of time. The second input terminal of the second symbol-level correlator bank 902 receives the preamble

$$p [ k - 2 \cdot \frac{N}{2} , {UE}_{u} ] ,$$

which is p[k, UEᵤ] delayed by two units of time. The second input terminal of the n-th symbol-level correlator bank 90n receives the preamble

$$p [ k - n \cdot \frac{N}{2} , {UE}_{u} ] ,$$

which is p[k, UEᵤ] delayed by n units of time. Each symbol-level correlator bank 900 to 90n outputs the corresponding likelihood measures X_{NC,u} for the delayed time.

FIG. 10 illustrates a block diagram of the n-th symbol-level correlator bank 90n for UEᵤ in a communication system suitable for non-terrestrial networks (NTNs) according to an exemplary embodiment of the present invention. Referring to FIG. 10, the n-th symbol-level correlator bank 90n includes multiple correlation evaluation units 1000. Each correlation evaluation unit 1000 comprises a first multiplication circuit 1001, a complex conjugate circuit 1002, a second multiplication circuit 1003, a first shift register group 1004, a first sum calculator 1005, a magnitude-squared calculator 1006, a second shift register group 1007, and a second sum calculator 1008.

The first input terminal of the first multiplication circuit 1001 of the first correlation evaluation unit 1000 receives a frequency shift signal e^{j2π(-3)Δfk}, which carries out a frequency shift of a residual frequency error candidate, (−3)Δf. The first input terminal of the first multiplication circuit 1001 of the second correlation evaluation unit 1000 receives a frequency shift signal e^{j2π(-2.5)Δfk}, which carries out a frequency shift of a residual frequency error candidate, (−2.5)Δf; and so on. The second input terminal of the first multiplication circuit 1001 receives the delayed preamble

$$p [ k - n \frac{N}{2} , {UE}_{u} ] .$$

The input terminal of the complex conjugate circuit 1002 is coupled to the output terminal of the first multiplication circuit 1001, for performing a complex conjugate operation to the output of the first multiplication circuit 1001, and outputs the result. The first input terminal of the second multiplication circuit 1003 receives the aforementioned received signal r[k], and the second input terminal of the second multiplication circuit 1003 is coupled to the output of the complex conjugate circuit 1002. In this embodiment, the purpose of the complex conjugate circuit 1002 is to match the delayed preamble

$$p [ k - n \frac{N}{2} , {UE}_{u} ]$$

corresponding to the u-th user equipment. This allows for a measurement of the signal strength or power associated with the delayed preamble

$$p [ k - n \frac{N}{2} , {UE}_{u} ] .$$

This multiplication operation effectively computes the sample product between the received signal r[k] and the delayed preamble

$$p [ k - n \frac{N}{2} , {UE}_{u} ] ,$$

whose low-pass portion represents cross-correlation and can thus be used to extract information about the presence and position of the corresponding preamble buried in the received signal r[k], which is superimposed of many NPRACH preambles sent from various UE devices and is corrupted by various channel impairments and noise.

The first shift register group 1004 includes multiple shift registers, where the input terminal of the first shift register in the first shift register group 1004 is coupled to the output terminal of the second multiplication circuit 1003, and it receives and stores the output of the second multiplication circuit 1003 at each clock cycle. The first sum calculator 1005 includes multiple input terminals and an output terminal, where each input terminal of the first sum calculator 1005 is coupled to the output terminals of each shift register in the first shift register group 1004, in order to calculate the sum of the outputs from all shift registers in the first shift register group 1004. In this embodiment, since one symbol consists of N samples, the number of shift registers in the first shift register group 1004 is N, and every N clock cycles, the first sum calculator 1005 performs a summation calculation.

The input terminal of the magnitude-squared calculator 1006 is coupled to the output terminal of the first sum calculator 1005, to calculate the square of the magnitude of the result output by the first sum calculator 1005. Similarly, the second shift register group 1007 includes multiple shift registers. According to the above mathematical expression, the number of shift registers in this second shift register group 1007 is 20L because an NPRACH preamble contains 20 symbols and a likelihood measure is calculated over L preambles. The input terminal of the first shift register in the second shift register group 1007 is coupled to the output terminal of the magnitude-squared calculator 1006. Each input terminal of the second sum calculator 1008 is coupled to the output terminal of each shift register in the second shift register group 1007, in order to calculate the sum of the outputs from all shift registers in the second shift register group 1007, as the likelihood measure X_{NC}. For example, the second sum calculator 1008 of the first correlation evaluation unit 1000 outputs the likelihood measure

$${X}_{NC , u , L} [ ( - 3 ) Δ f , n \frac{N}{2} ] ,$$

corresponding to a residual time error of n times of a half symbol duration and a residual frequency error of (−3)Δf for UEᵤ; the second sum calculator 1008 of the second correlation evaluation unit 1000 outputs the likelihood measure

$${X}_{NC , u , L} [ ( - 2.5 ) Δ f , n \frac{N}{2} ] ,$$

corresponding to a residual time error of n times of a half symbol duration and a residual frequency error of (−2.5)Δf for UEᵤ; and so on.

However, as can be seen from the above implementation example, the hardware for this approach would be quite large. For example, a typical NB-IoT system has 48 preambles, with 14 RFE candidates and 10 RTE candidates. Therefore, the correlation evaluation unit 1000 would require at least 48×14×10=6720 units. In addition, this would require shift registers, which are integrated circuits that cannot be reduced in terms of area, making the area of integrated circuit very large and resulting in a very high complexity. Therefore, the following embodiment proposes a relatively simplified implementation circuit.

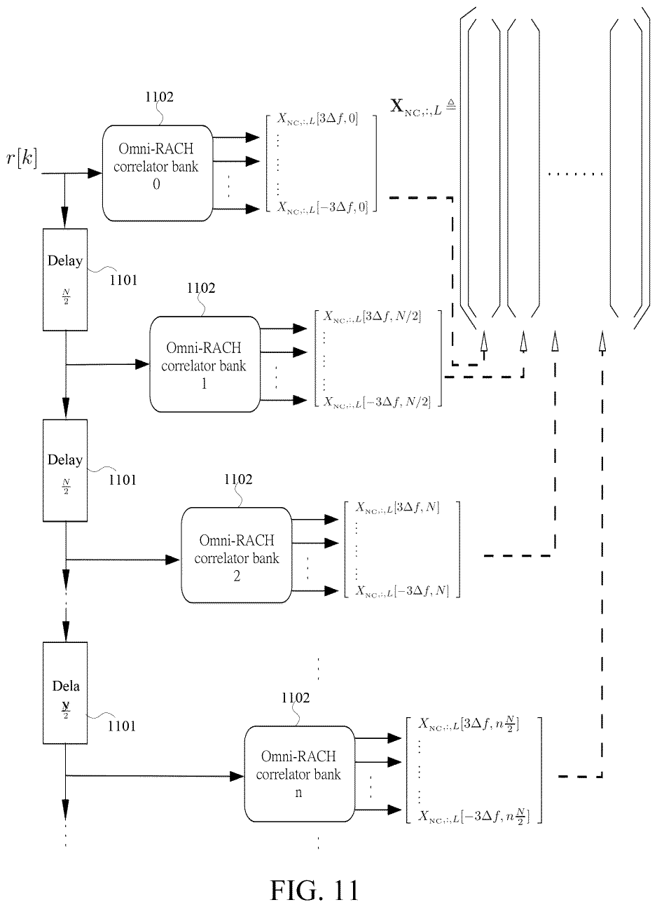

FIG. 11 illustrates a block diagram of the detection and estimation unit 603 for a communication system suitable for non-terrestrial networks (NTNs) according to an exemplary embodiment of the present invention. Referring to FIG. 11, in this embodiment, the detection and estimation unit 603 includes multiple delay units 1101 and multiple omni-RACH correlator banks 1102. The input terminal of the first delay unit 1101 receives the received signal r[k]; the output terminal of the first delay unit 1101 is coupled to the input terminal of the second delay unit 1101; the output terminal of the second delay unit 1101 is coupled to the input terminal of the third delay unit 1101 . . . and so on. The input terminal of the first omni-RACH correlator bank 1102 receives the received signal r[k]; the input terminal of the second omni-RACH correlator bank 1102 is coupled to the output terminal of the first delay unit 1101; the input terminal of the third omni-RACH correlator bank 1102 is coupled to the output terminal of the second delay unit 1101; and so on.

By comparing the above embodiment with the embodiment shown in FIG. 8, it can be seen that this embodiment performs time delay on the received signal r[k], rather than performing time delay on the preamble p[k, UEᵤ]. Additionally, in this embodiment, the 0th omni-RACH correlator bank 1102 outputs the likelihood measures X_{NC,;,L}[3Δf, 0]˜X_{NC,;,L}[(−3) Δf, 0]; the first omni-RACH correlator bank 1102 outputs

$${X}_{NC , : , L} [ 3 Δ f , \frac{N}{2} ] \sim {X}_{NC , : , L} [ ( - 3 ) Δ f , \frac{N}{2} ] ;$$

and the n-th omni-RACH correlator bank 1102 outputs

$${X}_{NC , : , L} [ 3 Δ f , n \frac{N}{2} ] \sim {X}_{NC , : , L} [ ( - 3 ) Δ f , n \frac{N}{2} ] .$$

As a result, each omni-RACH correlator bank 1102 independently outputs

$${X}_{NC , : , L} [ 3 Δ f , n \frac{N}{2} ] - {X}_{NC , : , L} [ ( - 3 ) Δ f , n \frac{N}{2} ] ,$$

which corresponds to different residual frequency errors for all user equipments with respect to a single RTE candidate

$$( i . e . , n \frac{N}{2} ) .$$

An omni-RACH correlator bank on a rake arm still corresponds to an RTE candidate.

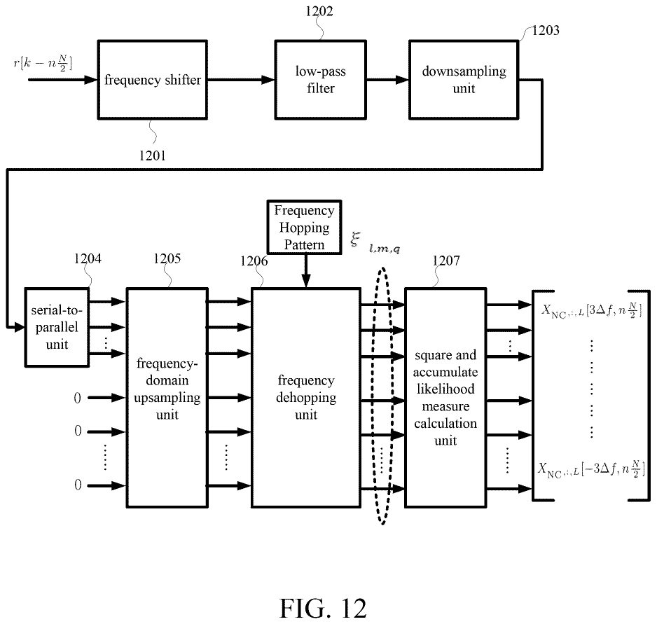

FIG. 12 illustrates a block diagram of the omni-RACH correlator bank 1102 of the detection and estimation unit 603 for a communication system suitable for non-terrestrial networks (NTNs) according to an exemplary embodiment of the present invention. Referring to FIG. 12, in this embodiment, the omni-RACH correlator bank 1102 is exemplified by the n-th omni-RACH correlator bank 1102. This omni-RACH correlator bank 1102 includes a frequency shifter 1201, a low-pass filter 1202, a downsampling unit 1203, a serial-to-parallel unit 1204, a frequency-domain upsampling unit 1205, a frequency dehopping unit 1206, and a square and accumulate likelihood measure calculation unit 1207.

In this embodiment, the input terminal of the frequency shifter 1201 is coupled to the output terminal of the n-th delay unit, which is the received signal delayed by n time units, i.e.,

$$r [ k - n \frac{N}{2} ] .$$

The frequency shifter 1201 is used to shift the spectra of the delayed received signal,

$$r [ k - n \frac{N}{2} ] ,$$

to the baseband. In this embodiment, the NB-IoT uplinks occupy the boundary bands of the 180-kHz band. Specifically, 24 NB-IoT subchannels are in the upper boundary band, and the other 24 NB-IoT subchannels are in the lower boundary band. The frequency shift task can be performed as follows:

$${r}_{dn} [ k ] = \frac{1}{2} ( r [ k ] \cdot {e}^{j 2 π ( \frac{N}{2} Δ f ) {kt}_{s}} + r [ k ] \cdot {e}^{- j 2 π ( \frac{N}{2} Δ f ) {kt}_{s}} ) = r [ k ] cos ( π k ) .$$

In other cases, the NB-IoT uplinks may occupy a frequency band centered at (f_{c}+δΔf), where f_{c} denotes the carrier frequency. The frequency shift task can be conducted as follows:

$${r}_{dn} [ k ] = r [ k ] \cdot {e}^{- j 2 π ( δΔ f ) {kt}_{s}} = {e}^{- j 2 π \frac{δ}{N} k} .$$

Then, by filtering the frequency-shifted signal, i.e., r_{dn}[k], with the low-pass filter 1202, the high-frequency components of the frequency-shifted signal, out-of-band interference from other applications and noise can be removed. In this embodiment, the low-pass filter 1202 can be implemented as a first-order infinite impulse response (IIR) low-pass filter, and its transfer function can be represented as follows:

$$H ( z ) = \frac{1 - a}{1 - a {z}^{- 1}}$$

where a=exp (−2πf_{cutoff}tₛ) and f_{cutoff} represents the cutoff frequency of the low-pass filter 1202. The above first-order infinite impulse response (IIR) low-pass filter 1202 confines its 3-dB bandwidth to ±f_{cutoff}. If f_{cutoff}=32Δf, then

$${t}_{s} = \frac{T}{N} = \frac{1}{N Δ f} ,$$

and therefore

$${f}_{cutoff} {t}_{s} = \frac{32 Δ f}{N Δ f} = \frac{32}{512} = \frac{1}{16} .$$

The above first-order IIR low-pass filter 1202 can tolerate frequency errors up to ±(32-24)Δf=±8Δf. The value of a in the transfer function can be substituted as

$$a = exp ( - 2 π \frac{1}{16} ) .$$

According to the Nyquist sampling theorem, the output data stream of the above first-order IIR low-pass filter 1202 can be downsampled by a factor of M_{D}=8, without loss of information and without spectral aliasing issue. The narrowband physical random access channel preamble occupies 48 subcarriers, and one NB-IoT symbol contains N=512 samples. Therefore,

$${M}_{D} = 8 ( = \frac{512}{64} < \frac{512}{48} )$$

is chosen, thereby reducing the subsequent computational complexity. The number of samples in a symbol is reduced from 512 samples/symbol to 64 samples/symbol

$$( i . e . , ( \frac{N}{{M}_{D}} = \frac{512}{8} = 64 ) ) ,$$

with no loss of information.

Therefore, in this embodiment, the input terminal of the downsampling unit 1203 is coupled to the output terminal of the low-pass filter 1202, in order to downsample the signal from the low-pass filter 1202. Therefore, dowsampling unit 1203 output a lower-rate stream, in which the sampling period becomes M_{D}tₛ and thus every symbol is sampled to have

$$\frac{N}{{M}_{D}} = \frac{512}{8} = 64$$

samples. The input terminal of the serial-to-parallel unit 1204 is coupled to the output terminal of the downsampling unit 1203, in order to arrange each series of

$$\frac{N}{{M}_{D}} = 64$$

samples in a symbol duration into

$$\frac{N}{{M}_{D}} = 64$$

parallel outputs.

Next, in order to improve the accuracy of residual frequency error (RFE) estimation, a frequency-domain (FD) upsampling method is employed, where each subchannel is divided into Mᵤ levels, where Mᵤ represents the frequency-domain (FD) upsampling factor. Frequency-domain (FD) upsampling is achieved by padding

$$\frac{N}{{M}_{D}} ( {M}_{u} - 1 )$$

zeros to the parallel outputs of the serial-to-parallel unit 1204. The resulting zero-padded sequence, which has a length of

$$\frac{N}{{M}_{D}} {M}_{u} ,$$

is applied to the fast Fourier transform (FFT) operation, with

$$\frac{{NM}_{u}}{{M}_{D}}$$

points at both its input and output ends. Therefore, in this embodiment, the frequency-domain upsampling unit 1205 is implemented using an FFT circuit with

$$\frac{{NM}_{u}}{{M}_{D}}$$

inputs, comprising

$$\frac{{NM}_{u}}{{M}_{D}}$$

input terminals and

$$\frac{{NM}_{u}}{{M}_{D}}$$

output terminals. The first

$$\frac{N}{{M}_{D}}$$

input terminals of the frequency-domain upsampling unit 1205 are correspondingly coupled to the

$$\frac{N}{{M}_{D}}$$

output terminals of the serial-to-parallel unit 1204, while the remaining

$$\frac{N}{{M}_{D}} ( {M}_{u} - 1 )$$

input terminals are set zero. The output terminal of the frequency-domain upsampling unit 1205 is configured to output the results of the

$$\frac{{NM}_{u}}{{M}_{D}} - point$$

Fast Fourier transform.

The frequency dehopping unit 1206 is coupled to multiple output terminals of the frequency-domain upsampling unit 1205. In this embodiment, the frequency dehopping unit 1206 includes the frequency hopping patterns for each user equipment. Therefore, the frequency spectra, i.e., the outputs of frequency-domain upsampling unit 1205, can be inversely shifted back according to the frequency hopping pattern for each user equipment. The spectral bins, which are the outputs of the frequency dehopping unit 1206, leave the residual frequency error for any given UE, with a range from −3Δf to 3Δf. Since the frequency dehopping unit 1206 can simultaneously extract and arrange the spectral bins according frequency hopping patterns corresponding to any of 48 user equipments and since an FFT circuit is adopted to replace 48 SLC banks corresponding to 48 user equipments, this embodiment significantly reduces the computational complexity. Subsequently, the square and accumulate likelihood measure calculation unit 1207 calculates the likelihood measures on the spectral bins that are output from multiple output terminals of the frequency dehopping unit 1206. These results are then output to the multiple output terminals of the square and accumulate likelihood measure calculation unit 1207.

Please compare the embodiments in FIG. 8 to FIG. 10 with those in FIG. 11 to FIG. 12. If we consider the mono-RACH likelihood measure implementation from FIG. 8 to FIG. 10, with a sampling rate where each symbol contains N samples, and the sampling period is tₛ, the computation for the symbol-level correlation (SLC) involves 2N complex multipliers. Therefore, the computational load for the mono-RACH likelihood measure in FIG. 8 to FIG. 10 can be expressed as 2N complex multipliers. According to Table 5, by sequentially adding parameters or multiplying factors, from the second row to the bottom row, such as (i) the number of residual frequency error (RFE) candidates N_{RFE}, (ii) the number of residual time error (RTE) candidates N_{RTE}, and (iii) the number of user equipment devices supported N_{UE}, the numbers of complex multiplications required for the two implementation methods can be calculated.

TABLE 5

| | mono-RACH SLC | omni-RACH |
|---|---|---|
| SLC | N + N | $\frac{N {M}_{u}}{2 {M}_{D}} {log}_{2} \frac{N {M}_{u}}{{M}_{D}}$ |
| Frequency Shifter and | | $\frac{N {M}_{u}}{2 {M}_{D}} {log}_{2} \frac{N {M}_{u}}{{M}_{D}} + 2 N$ |
| IIR LPF | | |
| squared magnitude | 2N + 1 | $\frac{N {M}_{u}}{2 {M}_{D}} {log}_{2} \frac{N {M}_{u}}{{M}_{D}} + \frac{N {M}_{u}}{{M}_{D}} + 2 N$ |
| Number of RFE | N_{RFE}(2N + 1) | $1 \cdot ( \frac{N {M}_{u}}{2 {M}_{D}} {log}_{2} \frac{N {M}_{u}}{{M}_{D}} + \frac{N {M}_{u}}{{M}_{D}} + 2 N )$ |
| candidates | | |
| Number of RTE | N_{RTE} · N_{RFE}(2N + 1) | ${N}_{R T E} ( \frac{N {M}_{u}}{2 {M}_{D}} {log}_{2} \frac{N {M}_{u}}{{M}_{D}} + \frac{N {M}_{u}}{{M}_{D}} + 2 N )$ |
| candidates | | |
| Number of UEs | N_{UE}N_{RTE}N_{RFE}(2N + 1) | ${N}_{R T E} ( \frac{N {M}_{u}}{2 M} {log}_{2} \frac{N {M}_{u}}{{M}_{D}} + \frac{N {M}_{u}}{{M}_{D}} + 2 N )$ |
| Example 1 | 559650 | 11200 |
| Example 2 | 2152500 | 16128 |

In Table 5, the parameters used in the Example 1 row are set as follows: N=512, L=16, RFE in [αΔf, βΔf], RTE in [0, γT], M_{D}=8, Mᵤ=2, N_{RFE}=(β−α)·Mᵤ+1, N_{RTE}=2γ+1, N_{UE}=6; while the parameters used in the Example 2 row are as follows: N=512, L=16, RFE in [αΔf, βΔf], RTE in [0, γT], M_{D}=8, Mᵤ=4, N_{RFE}=(β−α)·Mᵤ+1, N_{RTE}=2γ+1, N_{UE}=12, where, as stated in the above embodiment, β=−α=3, γ=3. People having ordinary skills in the art can clearly see that the improved embodiment in FIG. 11 to FIG. 12 significantly reduces the computational load, especially, when the number of UEs and/or the number of RFE candidates increase.

Although the preferred embodiments of FIG. 11 and FIG. 12 are illustrated using hardware implementations as examples, people having ordinary skills in the art should recognize that, with advancements in implementation technology, there is a high possibility that the preferred embodiments of FIG. 11 and FIG. 12 could also be implemented using software, hardware, software-defined radio or hybrid of them. Therefore, the present invention is not limited to the preferred embodiments of FIG. 11 and FIG. 12.

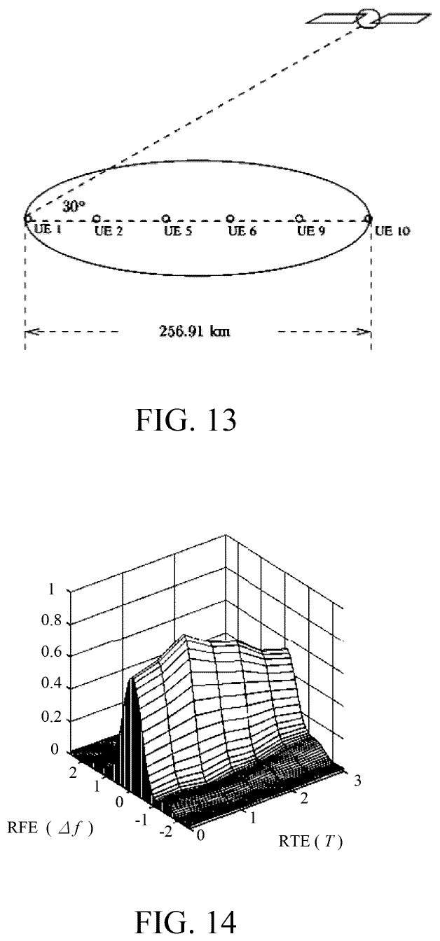

FIG. 13 illustrates a simulation environment diagram for likelihood measures in a communication system suitable for non-terrestrial networks (NTNs) according to an exemplary embodiment of the present invention. Referring to FIG. 13, in this embodiment, there are six user equipment devices UE₁, UE₂, UE₅, UE₆, UE₉, UE₁₀ in an active state.

Referring to FIG. 7, the simulation scenario is that only User Equipment 9 (UE 9) is in an active state, with a residual frequency error (RFE) of −0.5590Δf and a residual time error (RTE) of 1.0186T. After passing through an infinite impulse response (IIR) low-pass filter (LPF) 1202, downsampling is performed with a factor of M_{D}=8, followed by zero-padding to form a sequence at a rate of

$$\frac{{NM}_{u}}{{M}_{D}}$$

samples/symbol. The resulting sequence is then fed into a Fast Fourier Transform (FFT) with

$$\frac{{NM}_{u}}{{M}_{D}}$$

points. The outputs from the FFT 1205 are then fed into the dehopping unit 1206. In FIG. 7, the frequency-domain upsampling factor Mᵤ=2. FIG. 14 illustrates a simulation diagram for likelihood measures in a communication system suitable for non-terrestrial networks (NTNs) according to an exemplary embodiment of the present invention. Referring to FIG. 14, the environment setup is the same as in the embodiment of FIG. 7, but the frequency-domain upsampling factor is changed to Mᵤ=16. People having ordinary skills in the art will recognize that when the frequency-domain upsampling factor Mᵤ is increased to 16, the estimation precision of residual frequency error is raised as FIG. 7 becomes FIG. 14. Similarly, the upsampling factor Mᵤ and downsampling factor M_{D} can be chosen based on different design requirements, environments, and accuracy requirements. Therefore, the present invention is not limited thereto.

Table 6 presents the environment shown in FIG. 13, where six user equipment devices (UE1, UE2, UE5, UE6, UE9, UE10) are in an active state. Using the communication method/system suitable for Non-Terrestrial Networks (NTNs) as described in the exemplary embodiment of the present invention, the calculated values for elevation angle, slant range, Doppler frequency, frequency-domain pre-compensation parameter, frequency-domain post-compensation parameter, time-domain pre-compensation parameter and time-domain post-compensation parameter, the residual frequency error and residual time error are obtained and are listed in Table 6.

TABLE 6

| | UE 1 | UE 2 | UE 5 | UE6 | UE9 | UE 10 |
|---|---|---|---|---|---|---|
| RFE (Δf) | 1.1705 | 0.8285 | 0.4400 | −0.0830 | −0.5590 | −1.1705 |
| RTE (T) | 5.3217 | 4.2173 | 3.1302 | 2.0631 | 1.0186 | 0.0000 |
| Elevation Angle | 30.00° | 31.4280° | 32.9828° | 34.6794° | 36.5349° | 38.5679° |
| Slant Range (km) | 1075.0880 | 1030.9101 | 987.4295 | 944.7428 | 902.9623 | 862.2198 |
| Doppler Frequency (kHz) | 43.6274 | 42.9862 | 42.2576 | 41.4271 | 40.4774 | 39.3880 |
| Pre-/post-compensation (kHz) | 41.5077 | 41.5077 | 41.5077 | 41.5077 | 41.5077 | 41.5077 |
| Estimation Error (kHz) | −0.15 | −0.15 | +0.15 | −0.15 | −0.15 | −0.15 |
| RFE (kHz) | 4.3895 | 3.1070 | 1.6499 | −0.3111 | −2.2107 | −4.3895 |
| Propagation Delay (ms) | 3.5836 | 3.4364 | 3.2914 | 3.1491 | 3.0099 | 2.8741 |
| Pre-TA (ms) | 2.8741 | 2.8741 | 2.8741 | 2.8741 | 2.8741 | 2.8741 |
| Excess Time Delay (μs) | 709.5606 | 562.3007 | 417.3657 | 275.0764 | 135.8081 | 0.0000 |
| RTE (μs) | 1419.1212 | 1124.6012 | 834.7314 | 550.1628 | 271.6162 | 0.0000 |

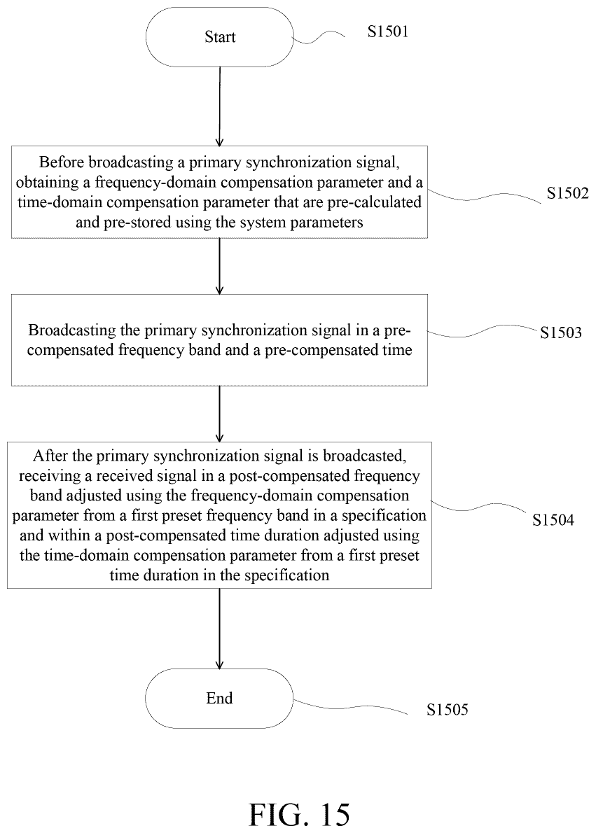

FIG. 15 illustrates a flowchart of pre-compensation and post-compensation in a communication method suitable for non-terrestrial networks (NTNs) according to an exemplary embodiment of the present invention. Referring to FIG. 15, the pre-compensation and post-compensation of this communication method suitable for NTNs are primarily intended to ensure that user equipments in the service area can receive the primary synchronization signal (PSS) within the specified time, as well as a base station (BS) can receive the random access preambles from user equipments (UEs) in the service area. The method includes the following steps:

### Step S1501: Start.

Step S1502: Before broadcasting a primary synchronization signal, obtaining a frequency-domain compensation parameter and a time-domain compensation parameter that are pre-calculated and pre-stored using the system parameters. The frequency-domain compensation parameter and time-domain compensation parameter can be calculated using factors such as elevation angle, satellite altitude, etc., and then stored in the base station. The base station can then directly use these parameters without online calculations.

Step S1503: Broadcasting the primary synchronization signal in a pre-compensated frequency band and within a pre-compensated time duration. Since the primary synchronization signal is defined in a preset frequency band and broadcast within a preset time duration (such as the fixed subframe in the above embodiment) as specified in the 3GPP specifications, the primary synchronization signal, in addition to requiring frequency adjustments using the frequency-domain compensation parameter, requires its broadcast time interval to be advanced. This ensures that all user equipments in the serviced cell can receive the primary synchronization signal within the subframe specified in the 3GPP specifications.

Step S1504: After the primary synchronization signal is broadcast, receiving a received signal in a post-compensated frequency band adjusted using the frequency-domain compensation parameter from a first preset frequency band in a specification and at a post-compensated time duration adjusted using the time-domain compensation parameter from a first preset time duration in the specification. In general, after receiving the primary synchronization signal, the user equipment will send random access preambles in the next subframe. These signals, in addition to being affected by propagation delay, will also be frequency-shifted due to the Doppler effect. Therefore, the base station not only needs to postpone the reception window but also needs to adjust the receiving frequency band in order to accurately receive signals from the user equipments in the serviced cell.

### Step S1505: End.

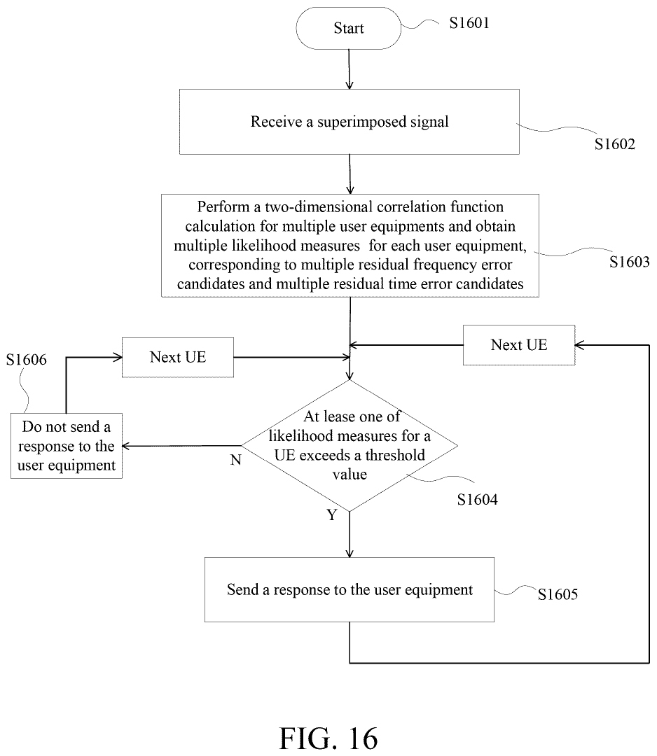

FIG. 16 illustrates a flowchart of identifying user equipments in a communication method suitable for non-terrestrial networks (NTNs) according to an exemplary embodiment of the present invention. Referring to FIG. 16, the steps for identifying user equipments in the communication method suitable for NTN include:
Step S1601: Start.
Step S1602: Receive a superimposed signal r[k].
Step S1603: Perform a two-dimensional correlation function calculation for multiple user equipments and obtain multiple likelihood measures X_{NC,u,L} for each user equipment, corresponding to multiple residual frequency error (RFE) candidates and multiple residual time error (RTE) candidates. Due to the characteristics of non-terrestrial networks (NTNs), both frequency and time are subject to undesirable effects, especially in narrowband communication, such as Narrowband Internet of Things (NB-IoT), where the signal spectra may be shifted beyond a designated band. Therefore, in this step, correlation calculations are performed for residual time errors (RTEs) and residual frequency errors (RFEs) with extended ranges, so that it is possible to determine whether a user equipment has accessed the network, and to identify its corresponding RTE and RFE.
Step S1604: Determine whether at least one of the multiple likelihood measures corresponding to a user equipment exceeds a threshold value. If yes, proceed to Step S1605. If no, proceed to Step S1606.
Step S1605: Send a response to the user equipment. For example, send a random access response (RAR). Additionally, when sending the response to the user equipment, the estimates of residual frequency error and residual time error are sent to the user equipment, so that the user equipment can use the estimates to perform correction for reducing ICI and improving the communication performance and robustness. Meanwhile, return to Step S1604 to continue the determination until the judgment for each user equipment is completed.
Step S1606: Do not send a response to the user equipment. Return to Step S1604 to continue the determination until the judgment for each user equipment is completed.

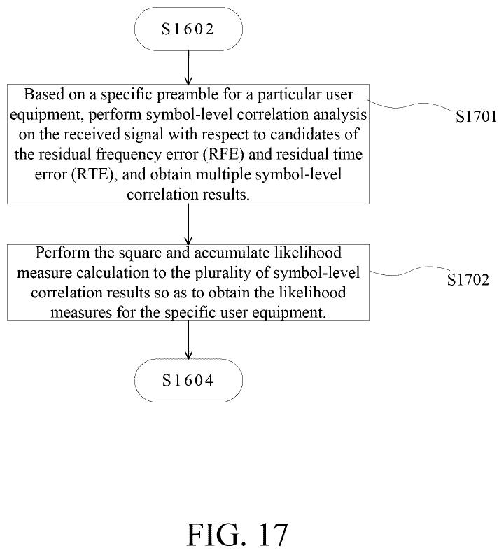

FIG. 17 illustrates a sub-step flowchart of Step S1603 of identifying user equipments in a communication method suitable for non-terrestrial networks (NTNs) according to an exemplary embodiment of the present invention. Referring to FIG. 17, the step for identifying user equipments in the communication method suitable for NTNs includes the following steps:

Step S1701: Based on a specific preamble of a particular user equipment, perform symbol-level correlation analysis on the received signal with respect to candidates of the residual frequency error and residual time error, and obtain multiple symbol-level correlation results. For example, as described in the previous embodiment, each preamble and received signal undergoes the two-dimensional correlation calculation. To calculate the residual time error and residual frequency error, each preamble must be individually delayed, such as

$$p [ k - n \frac{N}{2} ] ,$$

where n is the index for the residual time error (RTE index), and the delayed preamble

$$p [ k - n \frac{N}{2} ]$$

must also be multiplied by the frequency-shifting complex sinusoidal wave corresponding to the residual frequency error, e^{j2πMΔfk}, where Mis the index for the residual frequency error.

Step S1702: Perform the square and accumulate likelihood measure calculation to the plurality of symbol level correlation results so as to obtain the likelihood measures for the specific user equipment. Using the same intuitive approach as the mathematical derivations, the multiple likelihood measures X_{NC,u,L} for each user equipment can be computed.

Although the method described above is relatively more intuitive with respect to the mathematical derivations, its main drawback is the excessively high complexity.

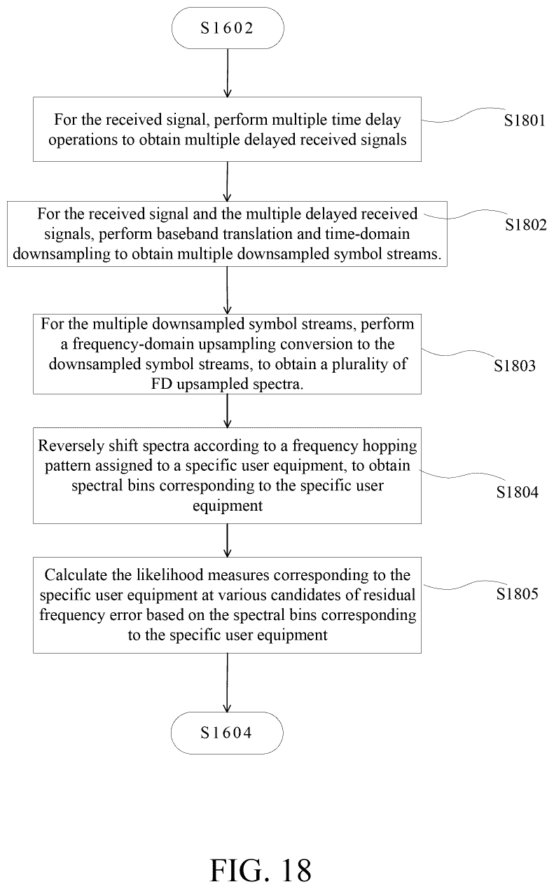

FIG. 18 illustrates a sub-step flowchart of Step S1603 of identifying user equipments in a communication method suitable for non-terrestrial networks (NTNs) according to an exemplary embodiment of the present invention. Referring to FIG. 8, the step for identifying user equipments in the communication method suitable for NTN includes the following steps:

Step S1801: For the received signal r[k], perform multiple time delay operations to obtain multiple delayed replicas of the received signals, i.e.,

$$r [ k - n \frac{N}{2} ] .$$

Here, n is the index for the residual time error (RTE index).

Step S1802: For the received signal and the multiple delayed replicas of the received signals, perform baseband translation and time-domain downsampling to obtain multiple downsampled symbol streams. As described in the previous embodiment, time-domain downsampling can effectively reduce the complexity of subsequent processes.

Step S1803: For the multiple downsampled symbol streams, perform a frequency-domain upsampling conversion to the downsampled symbol streams, to obtain a plurality of upsampled spectral data (in the frequency domain). The implementation of this step, for example, involves using an FFT unit with a size higher than the original sampling rate using zero padding on the remaining inputs, which results in upsampling in the frequency domain.

Step S1804: Reversely shift spectra according to a frequency hopping pattern assigned to a specific user equipment, to obtain spectral bins corresponding to the specific user equipment. During the reversely shift, spectral bins corresponding to the residual frequency error occurring with the specific user equipment can be left for all symbols; therefore, being captured.

Step S1805: Calculate the likelihood measures corresponding to the specific user equipment at various candidates of residual frequency error based on the spectral bins corresponding to the specific user equipment. In this way, the likelihood measures corresponding to each residual frequency error can be obtained.

Through the improvements to Step S1603 in the abovementioned embodiment, the complexity can be significantly reduced, moreover the overall area of the implementation circuit being reduced, while achieving the same results.

In summary, the preferred embodiment of the present invention proposes pre-compensation and post-compensation in both the frequency domain and the time domain. This can enable a non-terrestrial network (NTN) base station to successfully receive random access preambles sent by a user equipment on the ground, without changing the specifications of the user equipment. In another preferred embodiment, by performing two-dimensional likelihood measure calculations for multiple candidates of RFE and multiple candidates of RTE for each user equipment, the base station can correctly identify the user equipment that is in an active state. This, in turn, increases the success rate of random access requests from the user equipment. Furthermore, the two-dimensional likelihood measure calculation in the preferred embodiment of the present invention can also yield RFE estimate and RTE estimate. The base station can transmit these estimates to the corresponding user equipment detected active. As a result, the user equipment can use these estimates to adjust its local oscillator both in the time domain and in the frequency domain to improve the communication quality for non-terrestrial networks (NTNs).

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A communication system, comprising:
a base station including:
a detection and estimation unit, receiving a received signal, configured to perform a two-dimensional correlation function calculation for multiple user equipments and obtain a plurality of likelihood measures at candidates of residual frequency error and candidates of residual time error for each user equipment, to detect whether a user equipment is considered active based on whether at least one of the plurality of likelihood measures corresponding to the user equipment exceeds a threshold value; and
a dedicated channel transmission, in communication with the detection and estimation unit, configured to deliver a response to the user equipment considered active.

2. The communication system of claim 1,
wherein the detection and estimation unit obtains an estimate of residual frequency error and an estimate of residual time error corresponding to a user equipment considered active based on peak search of the plurality of likelihood measures corresponding to the specific user equipment with respect to the candidates of residual frequency error and residual time error; and
wherein the dedicated channel transmission delivers the estimates of residual frequency error and residual time error to the specific user equipment considered active via a dedicated channel for adjusting frequency and time.

3. The communication system of claim 1, wherein the base station, which emits a communication beam toward the Earth's surface, further comprises a compensation unit,
wherein, before the base station broadcasts a primary synchronization signal, the compensation unit obtains a frequency-domain compensation parameter and a time-domain compensation parameter that are pre-calculated and pre-stored using system parameters, and
wherein, after the primary synchronization signal is broadcast, the base station receives a received signal in a post-compensated frequency band adjusted using the frequency-domain compensation parameter from a first preset frequency band in a specification and within a post-compensated time duration adjusted using the time-domain compensation parameter from a first preset time duration in the specification to compensate for a frequency shift and a timing delay.

4. The communication system of claim 3, wherein
the base station broadcasts the primary synchronization signal on a pre-compensated frequency band adjusted using the frequency-domain compensation parameter from a second preset frequency band and within a pre-compensated time duration adjusted using the time-domain compensation parameter from a second preset time duration,
wherein according to the specification, the primary synchronization signal is specified to be broadcast on the second preset frequency band and within the second preset time duration.

5. The communication system of claim 1, wherein the detection and estimation unit comprise:
a plurality of mono-random-access-channel (mono-RACH) likelihood measure computation units, wherein each mono-RACH likelihood measure computation unit comprises a plurality of symbol-level correlator banks,
wherein each of the symbol-level correlator banks comprises a first input terminal, a second input terminal, and a plurality of output terminals, wherein the first input terminal of each of the symbol-level correlator banks receives the received signal, the second input terminal of the J-th symbol-level correlator bank receives the preamble signal of a corresponding user equipment with a delay of (J−1) time units, and the plurality of output terminals of the J-th symbol-level correlator bank respectively output likelihood measures of the corresponding user equipment under J−1 time units delay with various candidates of residual frequency error, wherein J is a natural number representing the index of the symbol-level correlator banks, with J being less than or equal to total number of symbol-level correlator banks and total number of candidates of residual time error.

6. The communication system of claim 5, wherein each of the symbol-level correlator banks comprises:
a plurality of correlation evaluation units, each of the correlation evaluation units comprises:
a first multiplication circuit, comprising a first input terminal, a second input terminal, and an output terminal, wherein the first input terminal of the first multiplication circuit of each correlation evaluation unit receives a frequency shift signal with shift of various candidates of residual frequency error, and the second input terminal of the first multiplication circuit of the J-th symbol-level correlator bank of the I-th mono-RACH likelihood measure computation unit receives the preamble signal of the I-th user equipment with a delay of (J−1) time units;
a conjugate circuit, comprising an input terminal and an output terminal, wherein the input terminal of the conjugate circuit is coupled to the output terminal of the first multiplication circuit, configured to perform a conjugate operation on the result from the output terminal of the first multiplication circuit, outputs the result;
a second multiplication circuit, comprising a first input terminal, a second input terminal, and an output terminal, wherein the first input terminal of the second multiplication circuit receives the received signal, and the second input terminal of the second multiplication circuit is coupled to the output terminal of the conjugate circuit;
a first shift register group, comprising a plurality of shift registers, wherein the input terminal of the first shift register in the first shift register group is coupled to the output terminal of the second multiplication circuit;
a first sum calculator, comprising a plurality of input terminals and an output terminal, wherein each input terminal of the first sum calculator is correspondingly coupled to the output terminal of each shift register in the first shift register group, configured to calculate the sum of the outputs of all shift registers in the first shift register group;
a magnitude-squared calculator, comprising an input terminal and an output terminal, wherein the input terminal of the magnitude-squared calculator is coupled to the output terminal of the first sum calculator, configured to calculate the square of the magnitude of the output from the first sum calculator;
a second shift register group, comprising a plurality of shift registers, wherein the input terminal of the first shift register in the second shift register group is coupled to the output terminal of the magnitude-squared calculator; and
a second sum calculator, comprising a plurality of input terminals and an output terminal, wherein each input terminal of the second sum calculator is correspondingly coupled to the output terminal of each shift register in the second shift register group, configured to calculate the sum of the outputs of all shift registers in the second shift register group,
wherein the second sum calculator of each correlation evaluation unit in the J-th symbol-level correlator bank of the I-th mono-RACH likelihood measure computation unit respectively outputs the plurality of likelihood measures corresponding to candidates of residual frequency error for the I-th active user equipment with a delay of the (J−1)-th candidate of residual time error.

7. The communication system of claim 1, wherein the detection and estimation unit comprises:
a plurality of delay units, each delay unit comprising an input terminal and an output terminal, wherein the input terminal of the first delay unit receives the received signal, and the output terminal of the P-th delay unit is coupled to the input terminal of the (P+1)-th delay unit; and
a plurality of omni-RACH correlator banks, each omni-RACH correlator bank comprising an input terminal and a plurality of output terminals, wherein the input terminal of the Q-th omni-RACH correlator bank is coupled to the output terminal of the (Q−1)-th delay unit, and the input terminal of the first omni-RACH correlator bank receives the received signal,
wherein the Q-th omni-RACH correlator bank outputs the plurality of likelihood measures corresponding to different candidates of residual frequency error for a specific user equipment with a frequency hopping pattern corresponding to the specific user equipment,
wherein P and Q are natural numbers, with P being less than the number of the delay units and with Q being greater than 1 and being less than the number of omni-RACH correlator banks.

8. The communication system of claim 7, wherein each of the omni-RACH correlator banks comprises:
a frequency shifter comprising an input terminal and an output terminal, wherein the input terminal of the frequency shifter of the Q-th omni-RACH correlator bank is coupled to the output terminal of the (Q−1)-th delay unit, for frequency-shifting the received signal with a delay of (Q−1) time units to a baseband;
a low-pass filter, comprising an input terminal and an output terminal, wherein the input terminal of the low-pass filter is coupled to the output terminal of the frequency shifter;
a downsampling unit, comprising an input terminal and an output terminal, wherein the input terminal of the downsampling unit is coupled to the output terminal of the low-pass filter, configured to downsample the signal resulting from the low-pass filter to obtain a low-rate stream with a rate of N/M_{D} samples/symbol;
a serial-to-parallel unit, comprising an input terminal and (N/M_{D}) output terminals, wherein the input terminal of the serial-to-parallel unit is coupled to the output terminal of the downsampling unit, configured to arrange every series of (N/M_{D}) samples into one set of the (N/M_{D}) output terminals;
a frequency-domain upsampling unit, comprising (N*Mᵤ/M_{D}) input terminals and a plurality of output terminals, wherein the first (N/M_{D}) input terminals of the frequency-domain upsampling unit are respectively coupled to the (N/M_{D}) output terminals of the serial-to-parallel unit, and the remaindering input terminals of the frequency-domain upsampling unit are all set 0, wherein the output terminals of the frequency-domain upsampling unit are configured to output results of (N*Mᵤ/M_{D})—point Fourier transform;
a frequency dehopping unit, comprising (N*Mᵤ/M_{D}) input terminals and (N*Mᵤ/M_{D}) output terminals, wherein the plurality of input terminals of the frequency dehopping unit are respectively coupled to the plurality of output terminals of the frequency-domain upsampling unit, and the frequency dehopping unit reversely shifts spectra according to a frequency hopping pattern assigned to a specific user equipment and outputs spectral bins corresponding to the specific user equipment to the plurality of output terminals of the frequency dehopping unit; and
a square and accumulate likelihood measure calculation unit, comprising a plurality of input terminals and a plurality of output terminals, wherein the square and accumulate likelihood measure calculation unit calculates likelihood measures corresponding to the specific user equipment at various candidates of residual frequency error based on the plurality of output terminals of the frequency dehopping unit, and outputs them to the plurality of output terminals of the square and accumulate likelihood measure calculation unit,
wherein N, M_{D} and Mᵤ are natural numbers with N denoting the sample number in a symbol duration, M_{D} denoting the time-domain downsampling factor, and Mᵤ representing the frequency-domain upsampling factor.

9. A communication system, comprising a base station, comprising a compensation unit,
wherein the base station emits a communication beam toward the Earth's surface, and the communication beam encompasses a specific service area;
wherein, before the base station broadcasts a primary synchronization signal, the compensation unit obtains a frequency-domain compensation parameter and a time-domain compensation parameter that are pre-calculated and pre-stored using system parameters; and
wherein, after the primary synchronization signal is broadcast, the base station receives a received signal in a post-compensated frequency band adjusted using the frequency-domain compensation parameter from a first preset frequency band in a specification and within a post-compensated time duration adjusted using the time-domain compensation parameter from a first preset time duration in the specification to compensate for a frequency offset and a timing delay.

10. The communication system of claim 9, wherein
the base station broadcasts the primary synchronization signal on a pre-compensated frequency band adjusted using the frequency-domain compensation parameter from a second preset frequency band and within a pre-compensated time duration adjusted using the time-domain compensation parameter from a second preset time duration, wherein according to the specification, the primary synchronization signal is specified to be broadcast on the second preset frequency band and within the second preset time duration.

11. The communication system of claim 9, wherein the base station further comprising:
a detection and estimation unit, receiving the received signal, configured to perform a two-dimensional correlation function calculation for multiple user equipments and obtain multiple likelihood measures at candidates of residual frequency error and at candidates of residual time error for each user equipment, to detect whether a user equipment is considered active based on whether at least one of the multiple likelihood measures corresponding to the specific user equipment exceeds a threshold value; and
a dedicated channel transmission, in communication with the detection and estimation unit, configured to deliver a response to the user equipment detected active in the detection and estimation unit.

12. The communication system of claim 11,
wherein the detection and estimation unit obtains an estimate of residual frequency error and an estimate of residual time error corresponding to a specific user equipment considered active based on peak search of the plurality of likelihood measures corresponding to the specific user equipment with respect to the candidates of residual frequency error and the candidates of residual time error; and
wherein the dedicated channel transmission delivers the estimates of residual frequency error and residual time error to the specific user equipment to adjust frequency and time of the specific user equipment.

13. The communication system of claim 11, wherein the detection and estimation unit comprises:
a plurality of mono-RACH likelihood measure computation units, wherein each mono-RACH likelihood measure computation unit comprises:
a plurality of symbol-level correlator banks, wherein each of the symbol-level correlator banks comprises a first input terminal, a second input terminal, and a plurality of output terminals, wherein the first input terminal of each of the symbol-level correlator banks receives the received signal, the second input terminal of the J-th symbol-level correlator bank receives the preamble signal of a corresponding user equipment with a delay of (J−1) time units, and the plurality of output terminals of the J-th symbol-level correlator bank respectively output likelihood measures for the corresponding user equipment with a delay of (J−1) time units and with various candidates of residual frequency error,
wherein J is a natural number representing the index of the symbol-level correlator banks, with J being less than or equal to total number of symbol-level correlator banks and total number of candidates of residual time error.

14. The communication system of claim 13, wherein each of the symbol-level correlator banks comprises:
a plurality of correlation evaluation units, each of the correlation evaluation units comprises:
a first multiplication circuit, comprising a first input terminal, a second input terminal, and an output terminal, wherein the first input terminal of the first multiplication circuit of each correlation evaluation unit receives a frequency shift signal with shift of various candidates of residual frequency error, and the second input terminal of the first multiplication circuit of the J-th symbol-level correlator bank of the I-th mono-RACH likelihood measure computation unit receives the preamble signal of the I-th user equipment with a delay of (J−1) time units;
a conjugate circuit, comprising an input terminal and an output terminal, wherein the input terminal of the conjugate circuit is coupled to the output terminal of the first multiplication circuit, configured to perform a conjugate operation on the result from the output terminal of the first multiplication circuit, and output the result;
a second multiplication circuit, comprising a first input terminal, a second input terminal, and an output terminal, wherein the first input terminal of the second multiplication circuit receives the received signal, and the second input terminal of the second multiplication circuit is coupled to the output terminal of the conjugate circuit;
a first shift register group, comprising a plurality of shift registers, wherein the input terminal of the first shift register in the first shift register group is coupled to the output terminal of the second multiplication circuit;
a first sum calculator, comprising a plurality of input terminals and an output terminal, wherein each input terminal of the first sum calculator is correspondingly coupled to the output terminal of each shift register in the first shift register group, configured to calculate the sum of the outputs of all shift registers in the first shift register group;
a magnitude-squared calculator, comprising an input terminal and an output terminal, wherein the input terminal of the magnitude-squared calculator is coupled to the output terminal of the first sum calculator, configured to calculate the square of the magnitude of the output from the first sum calculator;
a second shift register group, comprising a plurality of shift registers, wherein the input terminal of the first shift register in the second shift register group is coupled to the output terminal of the magnitude-squared calculator; and
a second sum calculator, comprising a plurality of input terminals and an output terminal, wherein each input terminal of the second sum calculator is correspondingly coupled to the output terminal of each shift register in the second shift register group, configured to calculate the sum of the outputs of all shift registers in the second shift register group,
wherein the second sum calculator of each correlation evaluation unit in the J-th symbol-level correlator bank of the I-th user equipment correlation computation unit respectively outputs the plurality of likelihood measures corresponding to different candidates of residual frequency error of the I-th active user equipment with a delay of (J−1) time units.

15. The communication system of claim 11, wherein the detection and estimation unit comprises:
a plurality of delay units, each delay unit comprising an input terminal and an output terminal, wherein the input terminal of the first delay unit receives the received signal, and the output terminal of the P-th delay unit is coupled to the input terminal of the (P+1)-th delay unit; and
a plurality of omni-RACH (omni-random access channel) correlator banks, each omni-RACH correlator bank comprising an input terminal and a plurality of output terminals, wherein the input terminal of the Q-th omni-RACH correlator bank is coupled to the output terminal of the (Q−1)-th delay unit, and the input terminal of the first omni-RACH correlator bank receives the received signal,
wherein the Q-th omni-RACH correlator bank outputs the plurality of likelihood measures corresponding to different candidates of residual frequency error for a specific user equipment according to the frequency hopping pattern assigned to the specific user equipment,
wherein P and Q are natural numbers, with P being less than the number of delay units and with Q being greater than 1 and less than the number of omni-RACH correlator banks.

16. The communication system of claim 15, wherein each of the omni-RACH correlator banks comprises:
a frequency shifter, comprising an input terminal and an output terminal, wherein the input terminal of the frequency shifter of the Q-th omni-RACH correlator bank is coupled to the output terminal of the (Q−1)-th delay unit, for frequency-shifting the received signal with a delay of (Q−1) time units to a baseband;
a low-pass filter, comprising an input terminal and an output terminal, wherein the input terminal of the low-pass filter is coupled to the output terminal of the frequency shifter;
a downsampling unit, comprising an input terminal and an output terminal, wherein the input terminal of the downsampling unit is coupled to the output terminal of the low-pass filter, configured to downsample the signal resulting from the low-pass filter to obtain a low-rate stream with a rate of N/M_{D} samples/symbol;
a serial-to-parallel unit, comprising an input terminal and (N/M_{D}) output terminals, wherein the input terminal of the serial-to-parallel unit is coupled to the output terminal of the downsampling unit, configured to arrange every series of (N/M_{D}) samples into one set of the (N/M_{D}) output terminals;
a frequency-domain upsampling unit, comprising (N*Mᵤ/M_{D}) input terminals and a plurality of output terminals, wherein the first (N/M_{D}) input terminals of the frequency-domain upsampling unit are respectively coupled to the (N/M_{D}) output terminals of the serial-to-parallel unit, and the remaindering input terminals of the frequency-domain upsampling unit are all set 0, wherein the output terminals of the frequency-domain upsampling unit are configured to output results of (N*Mᵤ/M_{D})—point Fourier transform;
a frequency dehopping unit, comprising (N*Mᵤ/M_{D}) input terminals and (N*Mᵤ/M_{D}) output terminals, wherein the plurality of input terminals of the frequency dehopping unit are respectively coupled to the plurality of output terminals of the frequency-domain upsampling unit, and the frequency dehopping unit reversely shifts spectra according to a frequency hopping pattern assigned to a specific user equipment and outputs spectral bins corresponding to the specific user equipment to the plurality of output terminals of the frequency dehopping unit; and
a square and accumulate likelihood measure calculation unit, comprising a plurality of input terminals and a plurality of output terminals, wherein the square and accumulate likelihood measure calculation unit calculates likelihood measures corresponding to the specific user equipment at various candidates of residual frequency error based on the plurality of output terminals of the frequency dehopping unit, and outputs them to the plurality of output terminals of the square and accumulate likelihood measure calculation unit,
wherein N, M_{D} and Mᵤ are natural numbers, with N denoting a sample number in a symbol duration, M_{D} denoting the time-domain downsampling factor, and Mᵤ representing the frequency-domain upsampling factor.

17. A communication method, comprising:
receiving a received signal;
performing a two-dimensional correlation function calculation to the received signal for multiple user equipments and evaluating multiple likelihood measures at candidates of residual frequency error and candidates of residual time error for each user equipment;
detecting whether a user equipment is considered active based on whether at least one of the multiple likelihood measures corresponding to the user equipment exceeds a threshold value; and
delivering a response to the user equipment considered active.

18. The communication method of claim 17, further comprising:
before broadcasting a primary synchronization signal, obtaining a frequency-domain compensation parameter and a time-domain compensation parameter that are pre-calculated and pre-stored using system parameters; and
after the primary synchronization signal is broadcast, receiving a received signal in a post-compensated frequency band adjusted using the frequency-domain compensation parameter from a first preset frequency band in a specification and within a post-compensated time duration adjusted using the time-domain compensation parameter from a first preset time duration in the specification to compensate a frequency offset and a timing delay.

19. The communication method of claim 18, further comprising:
broadcasting the primary synchronization signal on a pre-compensated frequency band adjusted using the frequency-domain compensation parameter from a second preset frequency band and within a pre-compensated time duration adjusted using the time-domain compensation parameter from a second preset time duration, wherein according to the specification, the primary synchronization signal is defined to be broadcast on the second preset frequency band and within the second preset time duration.

20. The communication method of claim 17, wherein performing the two-dimensional correlation function calculation to the received signal for multiple user equipments and calculating the plurality of likelihood measures at the candidates of residual frequency error and the candidates of residual time error for each user equipment, comprises:
performing a plurality of time delay operation to the received signal to obtain a plurality of delayed received signals;
performing a baseband translation and a time-domain downsampling to the received signal and the delayed received signals, to obtain a plurality of downsampled symbol streams;
performing a frequency-domain upsampling conversion to the downsampled symbol streams, to obtain a plurality of frequency-domain upsampled spectral information;
reversely shifting spectra according to a frequency hopping pattern assigned to a specific user equipment, to obtain spectral bins corresponding to the specific user equipment; and
calculating the likelihood measures corresponding to the specific user equipment at various candidates of residual frequency error based on the spectral bins corresponding to the specific user equipment.

21. The communication method of claim 17, wherein performing the two-dimensional correlation function calculation to the received signal for multiple user equipments and obtaining the plurality of likelihood measures at the candidates of residual frequency error and the candidates of residual time error for each user equipment, comprises:
performing symbol-level correlations to the received signal based on a specific preamble for a specific user equipment according to the residual frequency errors and the residual time errors to obtain a plurality of symbol-level correlation results; and
performing a square and accumulate likelihood measure calculation to the plurality of symbol-level correlation results so as to obtain the likelihood measures of the specific user equipment.

22. The communication method of claim 21, wherein performing the symbol-level correlations to the received signal based on the specific preamble for the specific user equipment according to the residual frequency errors and the residual time errors to obtain the plurality of symbol-level correlation results, comprises:
performing P x Q symbol-level correlations, wherein
[I, J] symbol-level correlation comprises:
multiplying a preamble with a delay of (I−1) time units for the specific user equipment with a complex sinusoidal carrying the J-th candidate of residual frequency error to obtain an [I, J] frequency-shifted preamble;
multiplying the [I, J] frequency-shifted preamble with the received signal to obtain an [I, J] sample product; and
accumulating a first preset number of [I, J] sample products to obtain [I, J] symbol-level correlation result,
wherein P, Q, I and J are natural numbers, and I is greater than 0 and smaller than P, and J is greater than 0 and smaller than Q.

23. The communication method of claim 21, wherein performing the square and accumulate likelihood measure calculation to the plurality of symbol-level correlation results so as to obtain the likelihood measures for the specific user equipment, comprises:
squaring an absolute value of the [I, J] symbol-level correlation result to obtain a square absolute symbol-level correlation result; and
accumulating a second preset number of square absolute symbol-level correlation result to obtain the [I, J] likelihood measure.

24. A communication method, comprising:
before broadcasting a primary synchronization signal, obtaining a frequency-domain compensation parameter and a time-domain compensation parameter that are pre-calculated and pre-stored using system parameters; and
after the primary synchronization signal is broadcast, receiving a received signal in a post-compensated frequency band adjusted using the frequency-domain compensation parameter from a first preset frequency band in a specification and within a post-compensated time duration adjusted using the time-domain compensation parameter from a first preset time duration in the specification to compensate a frequency offset and a timing delay.

25. The communication method of claim 24, further comprises:
broadcasting the primary synchronization signal on a pre-compensated frequency band adjusted using the frequency-domain compensation parameter from a second preset frequency band and within a pre-compensated time duration adjusted using the time-domain compensation parameter from a second preset time duration,
wherein according to the specification, the primary synchronization signal is defined to be broadcast on the second preset frequency band and within the second preset time duration.

26. The communication method of claim 24, further comprising:
receiving the received signal;
performing a two-dimensional correlation function calculation to the received signal for multiple user equipments and evaluating multiple likelihood measures at candidates of residual frequency error and candidates of residual time error for each user equipment;
detecting whether a user equipment is considered active based on whether at least one of the multiple likelihood measures corresponding to the user equipment exceeds a threshold value; and
delivering a response to the user equipment detected active.

27. The communication method of claim 26, wherein performing the two-dimensional correlation function calculation to the received signal for multiple user equipments and obtaining the plurality of likelihood measures at the candidates of residual frequency error and the candidates of residual time error for each user equipment, comprises:
performing a plurality of time delay operations to the received signal to obtain a plurality of delayed received signals;
performing a baseband translation and a time-domain downsampling to the received signal and the delayed received signals, to obtain a plurality of downsampled symbol streams;
performing a frequency-domain upsampling conversion to the downsampled symbol streams, to obtain a plurality of frequency-domain upsampled spectral data;
reversely shifting spectra according to a frequency hopping pattern assigned to a specific user equipment, to obtain spectral bins corresponding to the specific user equipment; and
calculating the likelihood measures corresponding to the specific user equipment at various candidates of residual frequency error based on the spectral bins corresponding to the specific user equipment.

28. The communication method of claim 26, wherein performing the two-dimensional correlation function calculation to the received signal for multiple user equipments and evaluating the plurality of likelihood measures at the candidates of residual frequency error and the candidates of residual time error for each user equipment, comprises:
performing symbol-level correlations to the received signal based on a specific preamble for a specific user equipment according to the residual frequency errors and the residual time errors to obtain a plurality of symbol-level correlation results; and
performing a square and accumulate likelihood measure calculation to the plurality of symbol-level correlation results so as to obtain the likelihood measures for the specific user equipment.

29. The communication method of claim 28, wherein performing the symbol-level correlations to the received signal based on the specific preamble for the specific user equipment according to the residual frequency errors and the residual time errors to obtain the plurality of symbol-level correlation results, comprises:
performing PxQ symbol-level correlations, wherein
[I, J] symbol-level correlation comprises:
multiplying a preamble with a delay of (I−1) time unit for the specific user equipment with a complex sinusoidal wave carrying a J-th candidate of residual frequency error to obtain an [I, J] frequency-shifted preamble in each of a first preset time duration;
multiplying the [I, J] frequency-shifted preamble with the received signal to obtain an [I, J] sample product in each of the first preset time duration; and
accumulating a first preset number of sample products to obtain the [I, J] symbol-level correlation result,
wherein P, Q, I and J are natural numbers, and I is smaller than P, and J is smaller than Q.

30. The communication method of claim 28, wherein performing the square and accumulate likelihood measure calculation to the plurality of symbol-level correlation results so as to obtain the likelihood measures for the specific user equipment, comprises:
squaring a magnitude of the [I, J] symbol-level correlation result in each of a second preset time duration to obtain a magnitude-squared symbol-level correlation result; and
accumulating a second preset number of magnitude-squared symbol-level correlation results after the second preset number of the second preset time duration to obtain the [I, J] likelihood measure.
